(19) United States
(12) Patent Application Publication
(10) Pub. No.: US 2025/0252450 A1
(43) Pub. Date: Aug. 7, 2025

(54) Artificial Intelligence – Blockchain Regulatory and Compliance Engine

(71) Applicant: TEACHERS INSURANCE AND ANNUITY ASSOCIATON OF AMERICA, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Vamsi Pola, Concord, NC (US)

(21) Appl. No.: 18/434,689

(22) Filed: Feb. 6, 2024

(51) Int. Cl. G06Q 30/018

(52) U.S. Cl. CPC G06Q 30/018; G06Q 2220/00

(57) ABSTRACT

The systems and methods disclosed herein relate to automating determination of regulatory compliance of financial accounts and/or transactions. In one embodiment, a method for automating regulatory compliance of a financial account includes generating a smart contract from a regulatory ruleset, transmitting the smart contract to at least one other participant in a distributed ledger network to deploy the smart contract, receiving a request from an organization regarding the regulatory compliance of the financial account, sending financial data to the smart contract, and providing, to the organization, regulatory compliance information without revealing the financial data.

### TECHNICAL FIELD

The present disclosure is generally directed to methods and systems for automating determination of regulatory compliance of financial accounts and/or transactions.

### BACKGROUND

The financial industry operates within a strict regulatory framework to protect investors and maintain stability. However, regulatory compliance processes using conventional tools can be cumbersome, error prone, and lack desired transparency. As authorities generate new financial regulations and/or update existing financial regulations, the conventional tools must be manually updated. Further, it is a challenge to provide proof of regulatory compliance to authorities in a manner that maintains account holders' privacy.

Distributed ledgers provide several advantages to centralized data storage, such as transparency, immutability, and redundancy, that make them attractive to the financial industry. But a distributed ledger's transparency may cause privacy issues, as financial transactions must be broadcast to the distributed ledger network for computation and validation.

### SUMMARY

Distributed ledger and/or artificial intelligence may be used to automate determination of regulatory compliance, including but not limited to global, country-specific, market-specific, and/or industry-specific financial regulations, for financial accounts and/or financial transactions.

In an exemplary embodiment, a computer-implemented method for automating regulatory compliance of a financial account includes (1) generating a smart contract from a regulatory ruleset, wherein the regulatory ruleset comprises programmatic logic for determining regulatory compliance, wherein the smart contract is configured to (a) receive financial data associated with the financial account, (b) determine from the financial data whether the financial account is compliant, and (c) responsive to determining that the financial account is compliant, generate regulatory compliance information, wherein the regulatory compliance information comprises cryptographic proof of regulatory compliance; (2) transmitting the smart contract to at least one other participant in the distributed ledger network to deploy the smart contract, wherein the smart contract is stored in a distributed ledger maintained by a network of participants; (3) receiving a request from an organization regarding the regulatory compliance of the financial account; (4) sending the financial data to the smart contract; and/or (5) providing, to the organization, the regulatory compliance information without revealing the financial data.

In an exemplary embodiment, a computer-implemented method for automating regulatory compliance of a financial transaction includes (1) generating a transactional smart contract from a transactional ruleset, wherein the transactional ruleset comprises programmatic logic for executing the financial transaction, wherein the transactional smart contract is configured to (a) receive one or more transaction inputs associated with the financial transaction, (b) execute the financial transaction using the one or more transaction inputs, and (c) generate one or more transaction outputs; (2) generating a regulatory smart contract from a regulatory ruleset, wherein the regulatory ruleset comprises programmatic logic for determining regulatory compliance, wherein the regulatory smart contract is configured to: (a) receive the one or more transaction inputs and the one or more transaction outputs, (b) determine from the one or more transaction inputs and the one or more transaction outputs whether the financial transaction is compliant, and (c) responsive to determining that the financial transaction is compliant, generate regulatory compliance information, wherein the regulatory compliance information comprises cryptographic proof of regulatory compliance; (3) transmitting the transactional smart contract and the regulatory smart contract to at least one other participant in the distributed ledger network to deploy the transactional smart contract and the regulatory smart contract, wherein the transactional smart contract and the regulatory smart contract are stored in a distributed ledger maintained by a network of participants; (4) sending the one or more transaction inputs to the transactional smart contract; (5) receiving a request from an organization regarding the regulatory compliance of the financial transaction; (6) sending the one or more transaction inputs and the one or more transaction outputs to the regulatory smart contract; and/or (7) providing, to the organization, the regulatory compliance information without revealing the one or more transaction inputs or the one or more transaction outputs.

The disclosed systems and methods improve computer security and data privacy by providing cryptographic regulatory compliance information to organizations without revealing private account or transaction data. That is, privacy and security may be improved by using the disclosed systems and methods to cryptographically store and transmit regulatory compliance information instead of traditionally providing private data to regulatory organizations. Moreover, the use of fully homomorphic encryption to securely store and process encrypted data in the distributed ledger further improves computer security.

In addition, the present disclosure includes specific features other than what is well-understood, routine, conventional activity in the field, or adding unconventional steps that confine the claim to a particular useful application, e.g., providing regulatory compliance information without revealing private financial data, as further described herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Additional, alternate and/or fewer actions, steps, features and/or functionality may be included in an aspect and/or embodiments, including those described elsewhere herein. Accordingly, the drawings and description are to be regarded as illustrative in nature and not as restrictive.

A distributed ledger is a mechanism for decentralized storage of data, events, transactions, etc. that is maintained by several participants. In particular, a distributed ledger achieves a distributed consensus on the validity or invalidity of information recorded in the distributed ledger. Instead of relying on a central authority or centralized storage, a distributed ledger is a decentralized database in which a transactional record of changes to the ledger is maintained and validated by each node of a peer-to-peer network. Thus, the distributed ledger provides a decentralized trust to participants and observers. One type of distributed ledger, a blockchain, comprises transactions grouped together into “blocks,” and ordered sequentially (thus the term “blockchain”). While the distributed ledgers discussed herein are referred to in the context of a blockchain, this is merely one example of a distributed ledger. Distributed ledgers may also include a tangle, a block lattice, or other directed acyclic graph (DAG). Nodes may join and leave the blockchain network over time and may obtain blocks from peer nodes that were propagated while the node was gone. Nodes may maintain addresses of other nodes and exchange addresses of known nodes with one another to facilitate the propagation of new information across the network in a decentralized, peer-to-peer manner.

The nodes that share the distributed ledger form what is referred to herein as the distributed ledger network. The nodes in the distributed ledger network validate changes to the blockchain (i.e., when a new transaction and/or block is created) according to a set of consensus rules. The consensus rules depend on the information being tracked by the blockchain and may include rules regarding the blockchain itself. For example, a consensus rule may require that the originator of a change supply a proof-of-identity such that only approved entities may originate changes to the blockchain. A consensus rule may require that blocks and transactions adhere to format requirements and supply certain metadata regarding the change (e.g., blocks must be below a size limit, transactions must include a number of fields, etc.). A consensus rule may include a mechanism for determining the order in which new blocks are added to the chain (e.g., through a proof-of-work system, proof-of-stake, etc.).

Additions to the blockchain that satisfy the consensus rules are propagated from nodes that have validated the addition to other known nodes. If all the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and the change is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable.

The validation activities of nodes applying consensus rules on a blockchain network may take various forms. In one implementation, the blockchain may be viewed as a shared spreadsheet that tracks data such as the ownership of assets. In another implementation, the validating nodes execute code contained in “smart contracts,” and distributed consensus is expressed as the network nodes agreeing on the output of the executed code.

A smart contract is a computer protocol that enables the automatic execution and/or enforcement of an agreement between different parties. In particular, the smart contract may be computer code that is located at a particular address on the blockchain. In some cases, the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds that are stored at the blockchain's address. In some scenarios when this balance reaches zero, the smart contract may no longer be operational.

The smart contract may include one or more trigger conditions, that, when satisfied, correspond to one or more actions. For some smart contracts, the action(s) performed may be determined based upon one or more decision conditions. In some instances, data streams may be routed to the smart contract so that the smart contract may detect that a trigger condition has occurred and/or analyze a decision condition.

Blockchains may be deployed in a public, decentralized, and permissionless manner meaning that any party may view the distributed ledger, submit new information to be added to the ledger, or join the network as a validating node. Other blockchains are private (e.g., permissioned ledgers) that keep chain data private among a group of entities authorized to participate in the blockchain network. Other blockchain implementations may be both permissioned and permissionless whereby participants may need to be validated, but only the information that participants in the network wish to be public is made public.

In some implementations, a distributed ledger includes multiple blockchains such as a main blockchain and several side chains operating independently of the main blockchain. The side chains then interact with the main blockchain to provide some of the transaction data from the side chains to the main blockchain. In this manner, the side chains can be private while the main blockchain is public or available to a larger number of entities than the side chains. Non-sensitive information from the side chains may be shared on the main blockchain. Also in some implementations, a distributed ledger includes multiple layers or separate blockchains executing in parallel that are maintained by the same validating nodes. Some of the transaction data from the blockchain for the first layer may be provided to the blockchain for the second layer or vice versa.

In one example, a distributed ledger may be maintained by validating nodes that transmit data to remote systems using one or more public and/or private networks, such as a private enterprise network, the Internet, a cellular router, a backhaul Internet, or other type of backhaul connection. The validating nodes receive transactions broadcasted to the distributed ledger network. The validating nodes then validate the broadcasted transactions. In some implementations, the storage centers are validating nodes such that the storage centers validate broadcasted transactions.

Artificial intelligence (AI) and/or distributed ledger technology may improve regulatory compliance by enabling automated oversight, real-time auditing, standardized regulations, decentralized compliance, and controlled testing environments for responsible innovation. By leveraging AI's data processing capabilities and/or distributed ledger's decentralized, transparent architecture, regulators can significantly enhance efficiency, accuracy, and transparency of compliance in the financial industry. AI and/or distributed ledgers may be used for automated monitoring and reporting, smart contracts that encode regulations into transactions, decentralized compliance frameworks, regulatory sandboxes to pilot innovations, and/or robust privacy safeguards. AI and/or distributed ledgers may streamline, strengthen, and modernize compliance.

Within the ever-evolving financial industry, AI and/or distributed ledgers may be used to ensure financial accounts comply with existing regulations. By making the most of AI's powerful data analysis and forecasting skills, the complex world of compliance may be simplified by a system that is automated and easy to monitor in real time. The system may perform regular checks on financial accounts and transactions, ensuring quicker rules compliance evaluations and reducing the need for conventional manual reviews. The system may provide analysis of how new or updated rules will change financial accounts. Custom advice may be provided that fits each customer's financial plans and goals, helping them get the most from their money while avoiding regulatory issues.

The system may enable continuous monitoring of financial accounts and advisors' practices to proactively identify potential compliance gaps or breaches. The system may detect omissions, errors, or oversights in compliance by reviewing financial account statements, filings, and transaction records. The system may generate personalized recommendations for improving compliance based on an individual's unique situation.

Automated web scraping and data aggregation from authoritative sources may be used to stay up-to-date on the latest regulations. The system may use natural language processing (NLP) to parse regulatory documents and extract key changes, effective dates, requirements etc.

The system may use oracles to allow external data to be incorporated into the regulatory compliance analysis. Decentralized oracle networks may securely feed external compliance data, like financial reports, into the system. Dedicated validator nodes operated by regulators may allow transaction level visibility in permitted distributed ledger networks. Distributed ledger workload tracking and multi-party computation may enable compliance analytics across borders without centralized aggregation.

Leveraging distributed ledger technology's immutable and decentralized properties may bolster transparency, security, accuracy, and efficiency of compliance processes. The system may rely on decentralized digital identity systems to give individuals greater control over their personal data while enabling selective disclosure to regulators. Self-sovereign identity systems may allow individuals to control their digital identities and selectively disclose verified credentials to regulators. Distributed ledger-based identities and data permissions minimize need for raw data sharing while preserving compliance requirements. Cryptographic verification of documents, credentials, and qualifications may be implemented across institutions and jurisdictions. Sensitive information stored on the distributed ledger may ensure that only authorized parties can access confidential data.

The system may generate automated and tamper-proof audit trails of transactions, information exchange, and legacy records. Permissioned access to compliance insights may be provided for regulators while preserving privacy. The system may implement granular access controls mediated through smart contracts to grant tailored access to compliance data without exposing unrelated personal information. Access control lists (ACLs) and permissions encoded in smart contracts may ensure compliance with data protection regulations across complex, interconnected IT systems. Hashing and on-chain anonymization of personal data may enable compliant analytics without exposing identity. Private/permissioned blockchain configurations allow granular access controls and history tailoring based on jurisdiction and use case. The system may implement compliance rules into smart contracts and decentralized applications. The system may use multi-signature protocols and zero-knowledge proofs (ZKPs) that enable auditing of compliance with data privacy laws and regulations without revealing underlying personal data.

The system may generate compliance non-fungible tokens (NFTs) that can encode regulatory status, permissions, qualifications as embedded metadata. Ownership of compliance NFTs may be audited and transferred through digital wallets. Smart contracts may build in expirations, review cycles, and permissions mapping directly into NFTs. Issuers of the compliance NFTs may permission and revoke compliance NFTs through customized ZKPs. Compliance NFTs may interoperate across jurisdictions and systems through distributed ledger interoperability protocols.

Regulations around transaction validation, data privacy, reporting requirements may be directly encoded into programmatic smart contract logic. The system may automatically execute this embedded compliance ruleset with each transaction, ensuring consistency. Validator nodes on the network may verify all execution results match the compliance protocol specified in the smart contract code. Automating transaction compliance reduces reliance on error-prone manual processes and provides transparency.

The system may record transaction inputs, transaction outputs, and execution logs are on the distributed ledger, which may provide a complete transparent audit trail for regulators to review compliance retroactively. Transaction data is tamper-proof due to the immutable nature of the distributed ledger. Smart contract logic may be visible to all participants, enabling collective code audits by participants. Events and monitoring hooks may be built into smart contract code to enable real-time notifications.

### BRIEF DESCRIPTION OF THE DRAWINGS

FIG. 1A illustrates a block diagram of a regulatory compliance computing system in accordance with an example aspect of the present disclosure;

FIG. 1B illustrates a block diagram of a digital wallet in accordance with an example aspect of the present disclosure;

FIG. 2 illustrates a block diagram of an exemplary regulatory monitoring module;

FIG. 3 illustrates an operation of an exemplary machine learning environment;

FIG. 4 illustrates a block diagram of an exemplary regulatory compliance module;

FIG. 5 illustrates an exemplary distributed ledger system for recording transactions and executing smart contracts in a decentralized file storage system;

FIG. 6 illustrates exemplary validating network nodes and an exemplary transaction flow on a distributed ledger network in a decentralized file storage system;

FIG. 7 illustrates an exemplary smart contract processing a transaction using fully homomorphic encryption;

FIG. 8A illustrates operation of an exemplary regulatory compliance environment;

FIG. 8B illustrates an exemplary access control list;

FIGS. 9A-9D illustrate exemplary sequence diagrams for determining regulatory compliance of a financial account and a financial transaction;

FIG. 10 illustrates a flow diagram representing an exemplary method for determining regulatory compliance of a financial account; and

FIG. 11 illustrates a flow diagram representing an exemplary method for determining regulatory compliance of a financial transaction.

### DETAILED DESCRIPTION

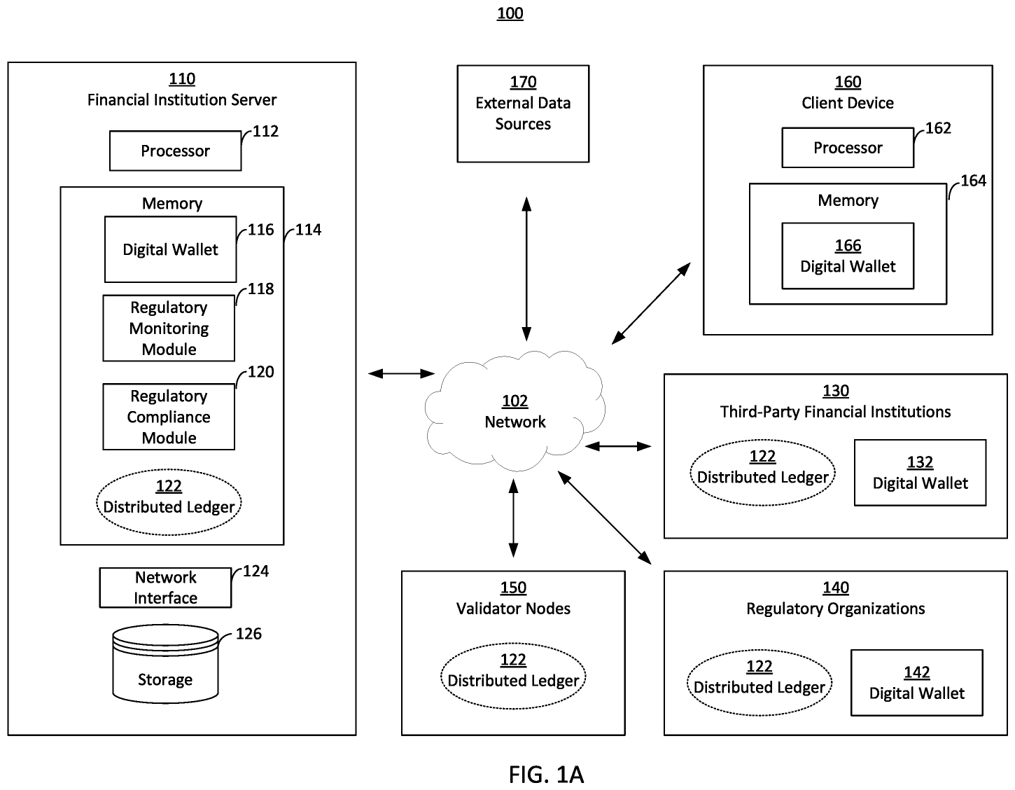

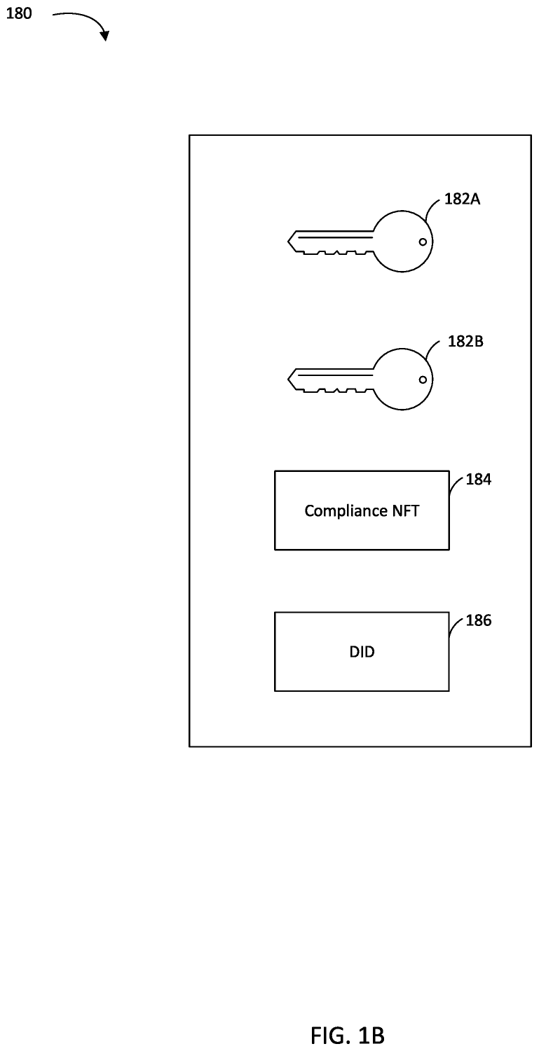

FIG. 1A illustrates various aspects of an example regulatory compliance computing system 100. The regulatory compliance system 100 may include one or more financial institution servers 110, third-party financial institutions 130, regulatory organizations 140, validator nodes 150, client devices 160, and external data sources 170, which may be communicatively connected through a network 102 as described below. One or more components of the regulatory compliance system 100 may be provided by virtual instances (e.g., one or more cloud-based virtualization services).

The financial institution server 110 may be associated with (e.g., owned/operated by) a company that sells and/or provides financial products and/or services. The financial institution server 110 may be an individual server, a group (e.g., cluster) of multiple servers, or another suitable type of computing device or system (e.g., a collection of cloud computing resources).

The financial institution server 110 may include one or more processors 112. The processor 112 may include any suitable number of processors and/or processor types, such as one or more central processing units (CPUs) and/or one or more graphics processing units (GPUs). Generally, the processor 112 is configured to execute software instructions stored in a memory 114.

The memory 114 may include one or more persistent memories (e.g., read only memory (ROM), a hard drive, solid state memory, etc.) and one or more transitory memories (e.g., a random access memory (RAM) and/or cache). The memory 114 may include an operating system, a plurality of software applications, and/or a plurality of software routines. The operating system includes any suitable operating system, such as Microsoft Windows, Linux, or UNIX. The memory 114 may store one or more sets of computer executable software routines, such a digital wallet 116, regulatory monitoring module 118, and/or a regulatory compliance module 120. The digital wallet 116, regulatory monitoring module 118, and regulatory compliance module 120 may be implemented in any programming language, e.g., Python, C, C++, HTML, JavaScript, etc. The digital wallet 116, regulatory monitoring module 118, and regulatory compliance module 120 may be implemented as compiled executables and libraries and/or interpretable source code. The memory 114 may include data such as a copy of a distributed ledger 122, user profiles, application data for the plurality of applications, routine data for the plurality of routines, and/or other data necessary to interact with the other components of the regulatory compliance system 100 through the network 102.

The financial institution server 110 may further include a network interface 124, such as wired/wireless controllers (e.g., Ethernet controllers). The network interface 124 facilitates communication over the network 102 between the financial institution server 110 and other components of the regulatory compliance system 100.

The financial institution server 110 may also include storage 126. The storage 126 may be used to store data and/or documents, such as financial regulations, account or transaction data, regulatory compliance data, and/or any other suitable data. The storage 126 may include a relational database, such as Oracle, DB2, MySQL, a NoSQL-based database, such as MongoDB, or another suitable database. The storage 126 may include a decentralized file storage system, such as the InterPlanetary File System (IPFS), Filecoin, a combination of these, or any other suitable decentralized file storage system.

According to embodiments, the third-party financial institution nodes 130, regulatory organization nodes 140, and validator nodes 150 may be a combination of hardware and software components. The third-party financial institution nodes 130 may be owned and/or operated by one or more financial institutions, such as banks, brokerage firms, retirement account providers, etc. The regulatory organization nodes 140 may be owned and/or operated by one or more governmental or industry regulatory organizations, such as the Securities and Exchange Commission (SEC) and the Internal Revenue Service (IRS). The financial institution server 110, third-party financial institution nodes 130, regulatory organization nodes 140, and/or validator nodes 150 may validate changes to the distributed ledger 122 (e.g., when a new transaction and/or block is created) according to a set of consensus rules. The third-party financial institution nodes 130 and/or regulatory organization nodes 140 may include digital wallets 132 and 142.

The financial institution server 110, third-party financial institution nodes 130, regulatory organization nodes 140, and/or validator nodes 150 may append distributed ledger data to the distributed ledger 122 if the distributed ledger data satisfies the consensus rules by generating a new block of validated transactions to include in the distributed ledger 122 and/or by broadcasting a block of transactions to other network nodes. Otherwise, the financial institution server 110, third-party financial institution nodes 130, regulatory organization nodes 140, and/or validator nodes 150 disregard any distributed ledger data that does not satisfy the consensus rules, and the distributed ledger data is not propagated to other network nodes.

The client device 160 may include, by way of example, a tablet computer, a personal digital assistant (PDA), a mobile device smartphone also referred to herein as a “mobile device,” a laptop computer, a desktop computer, a portable media player, a wearable computing device, a virtual reality headset, smart glasses, a smart watch, a phablet, another smart device, a device configured for wired or wireless RF (Radio Frequency), etc. Of course, any network-enabled device appropriately configured may interact with the regulatory compliance system 100. The client device 160 may communicate with the network 102 via wired or wireless signals and, in some instances, may communicate with the network 102 via an intervening wireless or wired device, which may be a wireless router, a wireless repeater, a base transceiver station of a mobile telephony provider, an optical communications device, etc. The client device 160 may be owned and/or operated by a financial institution account holder.

The client device 160 may include one or more processors 162, a memory 164, and other components not shown in FIG. 1A (e.g., a display, a communication unit, a user-input device, etc.), all of which may be interconnected via an address/data bus. The memory 164 may include the digital wallet 166, operating system, a data storage, a plurality of software applications, and/or a plurality of software routines. The operating system, for example, may include one of a plurality of mobile platforms such as the iOS®, Android™, Palm® webOS, Windows Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively.

According to embodiments, the external data sources 170 may be a combination of hardware and software components. The external data sources 170 may include government agencies, legal databases, news sites, financial market data sources, etc. The external data sources 170 may include public and/or private data sources. The external data sources 170 may provide data, such as financial market data or the text of regulations, to the financial institution server 110 and other network nodes. The external data sources 170 may provide the data via HTTP, HTTPS, a standardized or proprietary API, or any other suitable protocol.

The financial institution server 110, third-party financial institutions 130, regulatory organizations 140, validator nodes 150, client device 160, and external data sources 170 may communicate with each other via the network 102. The network 102 may be a proprietary network, a public Internet, a virtual private network, and/or some other type of network, such as dedicated access lines, plain ordinary telephone lines, satellite links, a wireless telephony network, combinations of these, etc. Where the network 102 comprises the Internet, data communication may take place over the network 102 via an Internet communication protocol.

FIG. 1B depicts an exemplary digital wallet 180, such as digital wallet 116, digital wallet 132, digital wallet 142, and digital wallet 166. The digital wallet 180 refers to an electronic account controlled by an owner that enables the owner to perform transactions, such as send, retrieve, and/or store digital assets. Examples of digital assets include currency (e.g., cryptocurrency and/or non-cryptocurrency), NFTs, etc. The digital wallet 180 stores, for each digital asset, information regarding the location of the digital asset on the distributed ledger 122. The digital wallet 180 may include a private key 182A, a public key 182B, and/or a compliance NFT 184. The private key 182A may be a secret key that the user or organization creates, which corresponds to the public key 182B, wherein the public key 182B is for public dissemination and the private key 182A is held strictly in confidence—i.e., is accessible only by the owner/controller of the digital wallet 180. The private key 182A is used to digitally sign transactions. For example, when a transaction is initiated, the digital wallet 180 can create a digital signature by processing the transaction with the private key 182A. The digital wallet 180 can be identified by the public key 182B. The public key 182B defines an address for the digital wallet 180 that others can use to send digital assets to the digital wallet 180. In this way, the owner that controls the digital wallet 180 exercises self-sovereignty of its identity, because it is exercising control over authentication and encryption of its private information rather than relying on a third party to control its private keys (e.g., as would be the case if the private key was stored by a third party and/or if symmetric key encryption was used).

The digital wallet 116 may implement decentralized identification (DID), such as DID 186. DIDs are globally unique identifiers comprising a string of letters and numbers that act as an identifying address on a distributed ledger. DIDs include a cryptographic private/public key pair. DID and self-sovereign identity may be implemented using a number of alternative technical architectures. However, for example, as shown in the W3C's DIDs recommendation, a decentralized identifier may be analogous to an HTTP uniform resource identifier (URI) insofar as that it is a human-readable string comprising a scheme, a method, and a method-specific identifier:

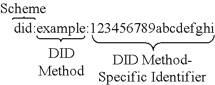

The above example DID string may resolve to an example DID document having the following definition:

```
{
  “@context”: [
    “https://www.w3.org/ns/did/v1”,
    “https:
  ]
  “id”: “did:example:123456789abcdefghi”,
  “authentication”: [{
      “id”: “did:example:123456789abcdefghi#keys-1”,
    “type”: “Ed25519VerificationKey2020”,
    “controller”: “did:example:123456789abcdefghi”,
    “publicKeyMultibase”: “zH3C2AVvLMv6gmMNam3uVAjZpfkcJCwDwnZn6z3wXmqPV”
  }]
}
```

The above example DID string may be under the control of a user or organization, and independent from any centralized authority, database, or registry.

DID 186 may be used to digitally sign, issue, and validate verifiable credentials (VCs), such as a regulatory compliance or educational degree certificate. A VC is a tamper-evident set of claims and metadata that cryptographically proves the issuer of the VC. A VC may be issued by packaging all of the relevant information and signing it with the issuer's private DID key. The issuer and content of the VC may be validated by decrypting the VC with the issuer's public DID key.

The compliance NFT 184 may be a certificate indicating that a financial account or financial transaction passed one or more regulatory compliance tests. The compliance NFT 184 may include compliance metadata formatted according to the ERC-721 standard. The compliance metadata may include issuer credentials, regulatory compliance status, a pointer to data in decentralized file storage, and/or expiration date. The compliance NFT 184 may be generated by a smart contract and recorded on the distributed ledger 122. The compliance NFT 184 may be subsequently transferred to the digital wallet 116 of the financial institution server 110 or the client device 160.

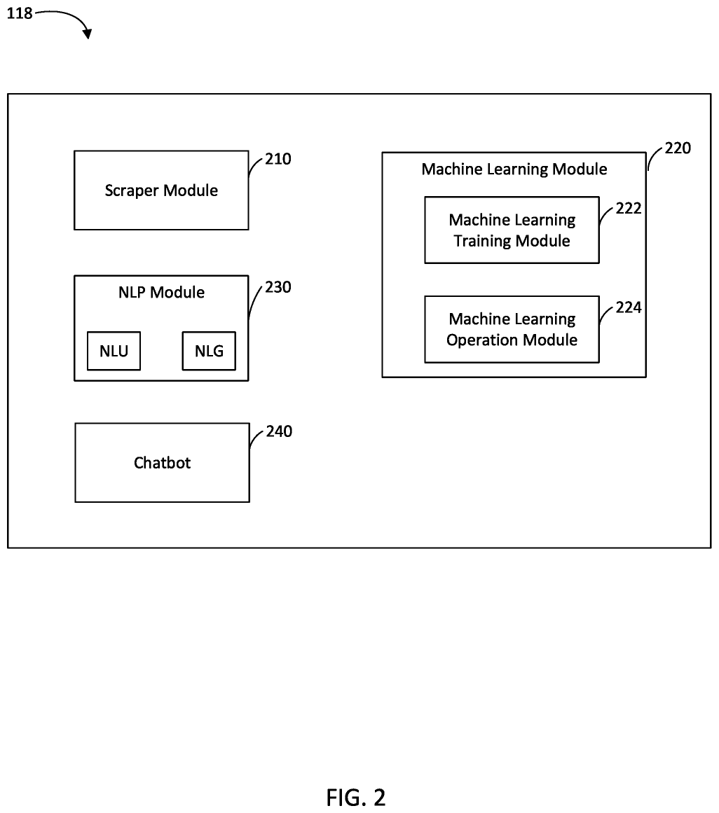

FIG. 2 depicts an exemplary regulatory monitoring module 116. The regulatory monitoring module 116 may monitor financial regulations, including but not limited to global, country-specific, market-specific, and/or industry-specific financial regulations, for updates and generate alerts, summaries, and/or regulatory compliance code. The regulatory monitoring module 116 may include a scraper module 210, an ML module 220, an NLP module 230, and/or a chatbot 240.

In one embodiment, the scraper module 210 periodically, e.g., daily or weekly, retrieves text from one or more external data sources 170. Alternatively, the scraper module 210 may be executed manually, e.g., by a financial institution administrator when a new regulation is announced. The retrieved text may include the text of financial regulations, such as tax laws, social security rules, pension regulations, etc. Financial regulations include but are not limited to global, country-specific, market-specific, and/or industry-specific financial regulations. The scraper module 210 may save the retrieved text into the storage 126. The scraper module 210 may include a web scraping tool, such as Scrapy, Selenium, or Beautiful Soup.

In one aspect, the ML module 220 may include ML training module (MLTM) 222 and/or ML operation module (MLOM) 224. The ML module 220 may apply at least one of a plurality of ML methods and algorithms, which may include, but are not limited to: linear or logistic regression, autoregressive integrated moving average (ARIMA), instance-based algorithms, regularization algorithms, decision trees, isolation forests, Bayesian networks, cluster analysis, association rule learning, artificial neural networks, deep learning, combined learning, reinforced learning, dimensionality reduction, and support vector machines. In various embodiments, the implemented ML methods and algorithms may be directed toward at least one of a plurality of categorizations of ML, such as supervised learning, unsupervised learning, and reinforcement learning. In one aspect, the ML based algorithms may be included as a library or package executed on the financial institution server 110. For example, libraries may include the TensorFlow based library, the PyTorch library, the HuggingFace library, and/or the scikit-learn Python library.

In one embodiment, the ML module 220 employs supervised learning, which involves identifying patterns in existing data to make predictions about subsequently received data. Specifically, the ML module may be “trained” (e.g., via MLTM 222) using training data, which includes example inputs and associated example outputs. Based upon the training data, the ML module 220 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 220 employs unsupervised learning, which involves finding meaningful relationships in unorganized data. Unlike supervised learning, unsupervised learning does not involve user-initiated training based upon example inputs with associated outputs. Rather, in unsupervised learning, the ML module 220 may organize unlabeled data according to a relationship determined by at least one ML method/algorithm employed by the ML module 220. Unorganized data may include any combination of data inputs and/or ML outputs as described above.

In yet another embodiment, the ML module 220 employs reinforcement learning, which involves optimizing outputs based upon feedback from a reward signal. Specifically, the ML module 220 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 222 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models.

The MLOM 224 may comprise a set of computer-executable instructions implementing ML loading, configuration, initialization, and/or operation functionality. The MLOM 224 may include instructions for storing trained models (e.g., in the storage 126). As discussed, once trained, the one or more trained ML models may be operated in inference mode, whereupon when provided with de novo input that the model has not previously been provided, the model may output one or more predictions, classifications, regulatory compliance evaluation code, knowledge graphs, data visualization presentations, forecast reports, personalized impact assessment reports, etc., as described herein.

In one embodiment, one or more NLP modules 230 comprise a set of computer-executable instructions implementing NLP, natural language understanding (NLU), and/or natural language generator (NLG) functionality. The NLP module 230 may be responsible for transforming the input (e.g., unstructured conversational input such as speech or text) to an interpretable format. The NLP module 230 may include an NLU to understand the intended meaning of utterances and/or prompts, among other things. The NLP module 230 may include an NLG, which may provide text summarization, machine translation, and dialog where structured data may be transformed into natural conversational language (i.e., unstructured) for output to the user. The NLP module 230 may comprise a bidirectional encoder representations from transformers (BERT) model.

In one embodiment, one or more chatbots 240 are programmed to simulate human conversation, interact with users, understand their needs, generate content (e.g., a customized presentation), and/or recommend an appropriate line of action with minimal and/or no human intervention, among other things. This may include providing the best response of any query that it receives and/or asking follow-up questions.

In some embodiments, the chatbots 240 discussed herein may be configured to utilize AI and/or ML techniques. For instance, the chatbot 240 may be a ChatGPT chatbot. The chatbot 240 may employ supervised or unsupervised machine learning techniques, which may be followed by, or used in conjunction with, reinforced or reinforcement learning techniques. The chatbot 240 may employ the techniques utilized for ChatGPT. The chatbot 240 may deliver various types of output for user consumption in certain embodiments, such as a dialog output, text or textual output (such as presented on a computer or mobile device screen or display), visual or graphical output, and/or other types of outputs.

Noted above, in some embodiments, a chatbot 240 or other computing device may be configured to implement ML, such that the financial institution server 110 “learns” to analyze, organize, and/or process data without being explicitly programmed. ML may be implemented through ML methods and algorithms. In one exemplary embodiment, the ML module 220 may be configured to implement the chatbot 240.

In operation, MLTM 222 may access storage 126 or any other data source for training data suitable to generate one or more ML models to generate the predictions, classifications, regulatory compliance evaluation code, knowledge graphs, data visualization presentations, forecast reports, personalized impact assessment reports, e.g., an ML module 220. The training data may be sample data with assigned relevant and comprehensive labels (classes or tags) used to fit the parameters (weights) of an ML model with the goal of training it by example. In one aspect, training data may include one or more example documents describing a financial regulation, example code for examining compliance with the financial regulation, example financial account and/or transaction data, and/or presentation style information. In one aspect, once an appropriate ML model is trained and validated to provide accurate predictions and/or responses, e.g., the ML module 220, the trained model and/or chatbot 240 may be loaded into MLOM 224 at runtime, may process the inputs and/or prompts, and may generate as an output conversational dialog and/or a customized presentation.

In one aspect, the chatbot 240 (e.g., an ML or AI chatbot) may include one or more ML models trained to generate one or more types of content for a customized communication, such as text component, audio component, images/video, slides, virtual reality, augmented reality, mixed reality component, multimedia, blockchain, and/or metaverse content, as well as any other suitable content.

While various embodiments, examples, and/or aspects disclosed herein may include training and generating one or more ML models and/or chatbot 240 for the financial institution server 110 to load at runtime, it is also contemplated that one or more appropriately trained ML models and/or chatbot 240 may already exist (e.g., in storage 126) such that the financial institution server 110 may load an existing trained ML model and/or chatbot 240 at runtime. It is further contemplated that the financial institution server 110 may retrain, update and/or otherwise alter an existing ML model and/or chatbot 240 before loading the model at runtime.

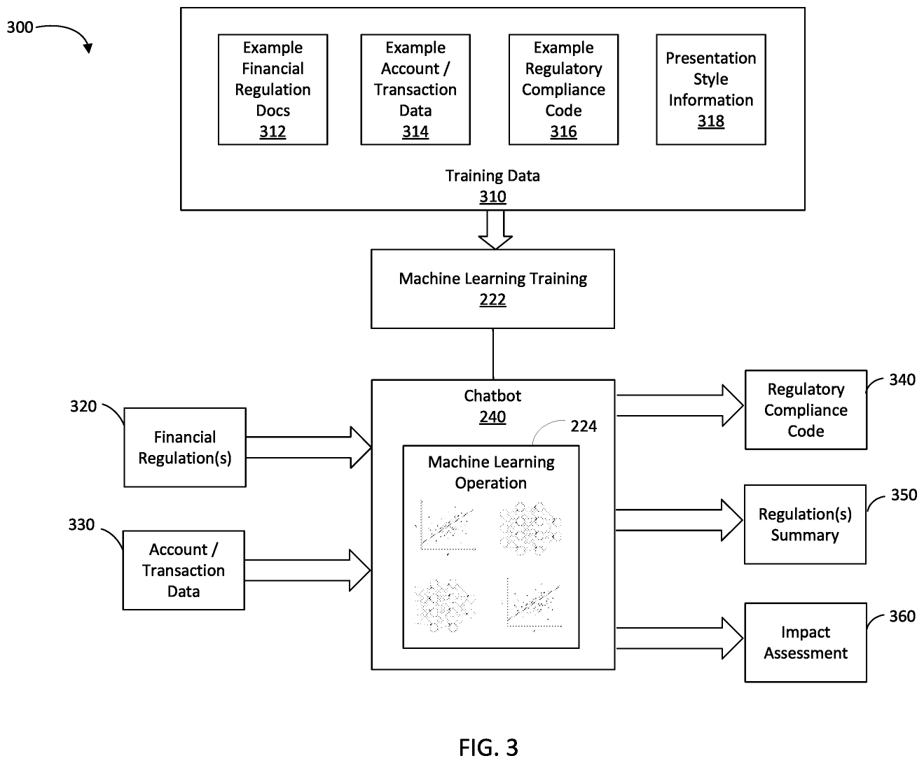

FIG. 3 schematically illustrates how an ML environment 300 may analyze financial regulations to determine compliance. Some of the blocks in FIG. 3 represent hardware and/or software components (e.g., block 222), other blocks represent data structures or memory storing these data structures, registers, or state variables (e.g., block 224), some blocks represent input data (e.g., block 320), and other blocks represent output data (e.g., block 340). Input and output signals are represented by arrows.

An ML module, such as ML module 220, may include one or more hardware and/or software components, such as the MLTM 222, to obtain, create, (re)train, operate and/or save one or more ML models, such as the MLOM 224. To generate an ML model, the MLTM 222 may use training data 310.

As described herein, the server such as financial institution server 110 may obtain and/or have available various types of training data 310 (e.g., stored in storage 126). In an aspect, the training data 310 may labeled to aid in training, retraining and/or fine-tuning the MLOM 224. The training data 310 may include exemplary financial regulation documents 312. The exemplary financial regulation documents 312 may comprise unstructured text comprising and/or describing financial regulations. The exemplary financial regulation documents 312 may be authored by government agencies, legal databases, or news sources and provide information about tax laws, social security rules, pension regulations, etc. New financial regulation documents 312 describing new and/or updated financial regulations may be used to retrain or update the MLOM 224.

The training data 310 may include examples of financial account and/or financial transaction data 314. The financial account and/or financial transaction data 314 may include unstructured text and/or structured data. The financial account and/or financial transaction data 314 may include account statements, balances, transaction histories, tax documents, and other financial records. The financial account and/or financial transaction data 314 may include information about an exchange of currencies, commodities, securities, etc.

The training data 310 may also include examples of regulatory compliance code 316. For example, the regulatory compliance code 316 may include source code comprising checks for compliance with one or more financial regulations. The regulatory compliance code 316 may be written in a smart contract programming language, such as Solidity or Vyper. The MLTM 222 may process this type of training data 310 to derive associations between the example financial regulation documents 312 and the regulatory compliance code 316 examples. For example, the example financial regulation documents 312 may describe required minimum distributions (RMDs), and the regulatory compliance code 316 examples may include checks for RMD compliance. Based upon the financial regulation documents and the regulatory compliance code examples, the MLTM 222 may train the MLOM 224 to generate regulatory compliance code 340 from new or updated financial regulations 320.

In one aspect, the training data 310 may include presentation style information 318 such as images, text, phonemes, audio, or other types of data which may be used as inputs as discussed herein for training the MLOM 224 to generate different types of presentation components. The presentation style information 318 may include style information related to a particular style (e.g., fonts, logos, emblems, colors, etc.) an organization would like the customized presentation components to emulate. The presentation style information 318 may include investor profile information which may affect customizing the presentation for a particular investor or organization, e.g., the sophistication level of a particular investor.

While the example training data includes indications of various types of training data 310, this is merely an example for ease of illustration only. The training data 310 may include any suitable data that may indicate associations between financial regulation 320 and/or account/transaction data 330 inputs and regulatory compliance code 340, regulation summary 350, and/or impact assessment 360 outputs. The MLOM 224 trained on such training data 310 will have an improved capability to generate the regulatory compliance code 340, regulation summaries 350, and/or impact assessments 360 when compared to a conventional ML chatbot.

In an aspect, the financial institution server 110 may continuously update the training data 310, e.g., based upon obtaining additional example financial regulation documents 312, example account/transaction data 314, example regulatory compliance code 316, presentation style information 318, feedback or data collected from prior account or transaction analyses, or any other training data. Subsequently, the MLOM 224 may be retrained/fine-tuned based upon the updated training data 310. Accordingly, the generation of regulatory compliance code 340, regulation summaries 350, and/or impact assessments 360 may improve over time.

In an aspect, the MLTM 222 may process and/or analyze the training data 310 to train the MLOM 224 to generate the regulatory compliance code 340, regulation summaries 350, and/or impact assessments 360. The MLOM 224 may be trained to generate the regulatory compliance code 340, regulation summaries 350, and/or impact assessments 360 via a large language model (LLM), neural network, deep learning model, Transformer-based model, generative pretrained transformer (GPT), generative adversarial network (GAN), regression model, k-nearest neighbor algorithm, support vector regression algorithm, isolation forests, and/or random forest algorithm, although any type of applicable ML model/algorithm may be used, including training using one or more of supervised learning, unsupervised learning, semi-supervised learning, and/or reinforcement learning.

In an aspect, the MLTM 222 may process and/or analyze the training data 310 to train the MLOM 224 to generate regulatory compliance code 340. The regulatory compliance code 340 may be embedded into a smart contract in a blockchain. The regulatory compliance code 340 may comprise a smart contract programming language, such as Solidity or Vyper. When executed, the regulatory compliance code 340 may examine a financial account and/or financial transaction for compliance with one or more financial regulations.

In an aspect, the MLTM 222 may process and/or analyze the training data 310 to train the MLOM 224 to generate a regulation summary 350. The regulation summary 350 may provide an analysis or summary of a financial regulation 320, including key changes from an older version of the financial regulation. The regulation summary 350 may be formatted according to the presentation style information in the training data 310. The regulation summary 350 may be in PowerPoint, PDF, HTML, video, audio, or any other suitable format. The regulatory summary 350 may be sent as an alert via text message or e-mail to individuals and/or financial advisors.

In an aspect, the MLTM 222 may process and/or analyze the training data 310 to train the MLOM 224 to generate an impact assessment 360. The impact assessment 360 may provide an analysis or summary of a financial regulation 320 on a financial account and/or financial transaction. The impact assessment 360 may be in PowerPoint, PDF, HTML, video, audio, or any other suitable format. The impact assessment 360 may be sent as an alert via text message or e-mail to individuals and/or financial advisors.

Once trained, the MLOM 224 may perform operations on one or more data inputs to produce a desired data output. In one aspect, the MLOM 224 may be loaded at runtime from a database (e.g., the storage 126) to process financial regulations 320 and/or account/transaction data 330 data input. The server, such as financial institution server 110, may obtain the financial regulations 320 and/or account/transaction data 330 and use it as an input to generate the regulatory compliance code 340, regulation summaries 350, and/or impact assessments 360. In one aspect, the server may obtain the financial regulations 320 via the scraper module 210, chatbot 240, and/or any other suitable source. In one aspect, the server may obtain the account/transaction data 330 via the third-party financial institutions 130, client device 160, or any other suitable source.

In one embodiment, the MLOM 224 may use a regression model to determine a severity score associated with the regulation summary 350 and/or impact assessment 360, which may be a preferred model in situations involving scoring output data.

Once generated by the MLOM 224, the regulatory compliance code 340 may be provided to regulatory compliance module 120 or to another device. The regulatory compliance module 120 may cause a new smart contract comprising a bytecode version of the regulatory compliance code 340 to be included in the blockchain. The generated regulation summary 350 and/or impact assessment 360 may be provided to the client device 160 or to another device. For example, the financial institution server 110 may provide the regulation summary 350 and/or impact assessment 360 via a mobile app to mobile device, in an email, a website, via a chatbot (such as the chatbot 240), and/or in any other suitable manner.

Generative AI/ML may enable a computer, such as the financial institution server 110, to use existing data (e.g., as an input and/or training data) such as text, audio, video, images, and/or code, among other things, to generate new content, such as regulatory compliance code 340, regulation summaries 350, and/or impact assessments 360 customized for an organization, via one or more models. Generative ML may include unsupervised and semi-supervised ML algorithms, which may automatically discover and learn patterns in input data. Once trained, e.g., via MLTM 222, a generative ML model may generate content as an output which plausibly may have been drawn from the original input dataset and may include the content in the customized presentation. In one aspect, an ML chatbot such as chatbot 240 may include one or more generative AI/ML models.

Some types of generative AI/ML may include GANs and/or transformer-based models. In one aspect, the GAN may generate images, visual and/or multimedia content from image and/or text input data. The GAN may include a generative model (generator) and discriminative model (discriminator). The generative model may produce an image which may be evaluated by the discriminative model and use the evaluation to improve operation of the generative model. Other types of generative AI/ML may use the GAN, the transformer model, and/or other types of models and/or algorithms to generate: (i) realistic images from sketches, which may include the sketch and object category as input to output a synthesized image; (ii) images from text, which may produce images (realistic, paintings, etc.) from textual description inputs; (iii) speech from text, which may use character or phoneme input sequences to produce speech/audio outputs; (iv) audio, which may convert audio signals to two-dimensional representations (spectrograms) which may be processed using algorithms to produced audio; and/or (v) video, which may generate and convert video (i.e., a series of images) using image processing techniques and may include predicting what the next frame in the sequence of frames/video may look like and generating the predicted frame. With the appropriate algorithms and/or training, generative AI/ML may produce various types of multimedia output and/or content which may be incorporated into a customized presentation, e.g., via an AI and/or ML chatbot (such as chatbot 240).

In one aspect, an enterprise may use the AI and/or ML chatbot, such as the trained chatbot 240, to generate one or more customized components of the customized regulation summary 350 and/or impact assessment 360. The trained ML chatbot may generate output such as images, video, slides (e.g., a PowerPoint slide), virtual reality, augmented reality, mixed reality, multimedia, blockchain entries, metaverse content, or any other suitable components which may be used in the customized presentation.

For example, the ML environment 300 may analyze the regulations regarding RMDs for retirement accounts. The financial regulations 320 may include text of IRS Publication 590-B obtained by the scraper module 210. The account/transaction data 330 may include details of an individual's retirement account(s), i.e., traditional IRA and 401(k) accounts, including the account holder's age, current total value of the retirement account(s), and total withdrawals from the retirement account(s) during the current tax year. The MLOM 224 may generate regulatory compliance code 340 for determining compliance with RMDs. The regulatory compliance code 340 may comprise a smart contract programming language. The regulatory compliance code 340 may comprise instructions for determining the account holder's distribution period based on the account holder's age. The regulatory compliance code 340 may divide the current total value of the retirement account(s) by the distribution period to calculate the RMD for the current tax year. The regulatory compliance code 340 may determine if the total withdrawals are greater than or equal to the RMD. The regulation summary 350 may provide an overview of the RMD regulation. The impact assessment 360 may provide an overview of the account holder's compliance status, including the account holder's RMD any additional withdrawals required to satisfy the RMD.

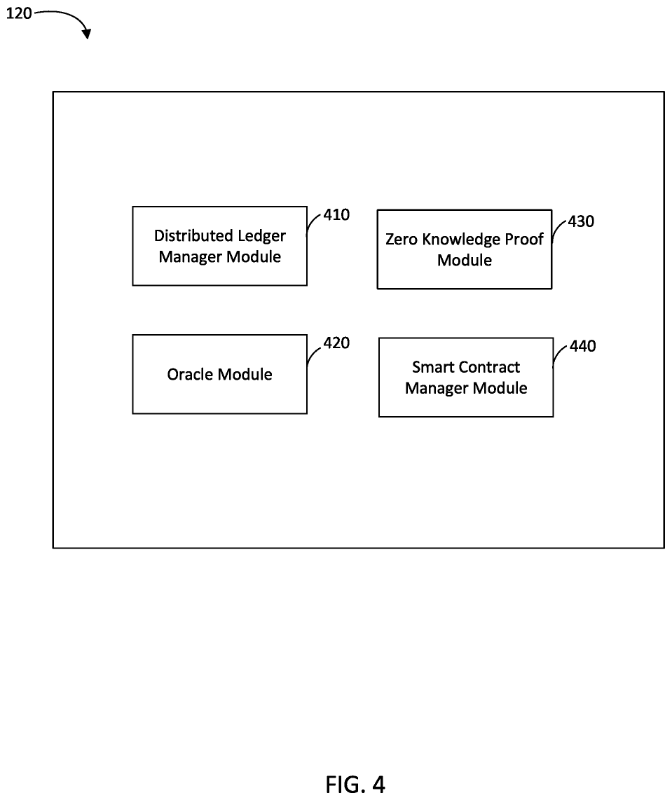

FIG. 4 depicts an exemplary regulatory compliance module 120. In addition to the financial institution server 110, one or more of the third-party financial institutions 130, regulatory organizations 140, and/or validator nodes 150 may include a regulatory compliance module 120. The regulatory compliance module 120 may determine compliance of financial accounts and/or financial transactions with financial regulations and provide proof of compliance. The regulatory compliance module 120 may include a distributed ledger manager module 410, oracle module 420, zero knowledge proof (ZKP) module 430, smart contract manager module 440, and/or a non-fungible token (NFT) module.

In one aspect, the distributed ledger manager module 410 performs operations on the distributed ledger network. The distributed ledger manager module 410 may create new blocks and/or validate blocks in the distributed ledger 122. The distributed ledger manager module 410 may communicate with other nodes in the distributed ledger network via the network interface 124 and network 102.

In one aspect, the oracle module 420 provides external data to the distributed ledger 122. The oracle module 420 may collect information external to the distributed ledger 122, e.g., financial market data, and transmit that information to the distributed ledger 122 where it can be used in the regulatory compliance process.

In one aspect, the ZKP module 430 executes one or more ZKPs, such as zero-knowledge Succinct Non-Interactive Arguments of Knowledge (zk-SNARKs) or Bulletproofs. ZKPs allow a prover (e.g., the financial institution server 110) to prove to another participant (e.g., the regulatory organizations 140) that a certain statement is true over a private input without disclosing any other information from that input other than whether the statement is true or not. ZKPs allow regulatory organizations 140 to accept cryptographic proof that a financial account and/or financial transaction is compliant without revealing private financial data.

For example, the financial institution server 110 can prove the account and/or transaction data is within a particular range (e.g., the account holder is at least 70 years old, the distributions from the retirement account are greater than the RMD, etc.) by obtaining a random seed and generating a signed proof statement using a hash chain along with encrypted user data. The financial institution server 110 then transmits the signed proof statement with the encrypted account and/or transaction data to prove that the account and/or transaction data is within the particular range.

The proof statement may be calculated by hashing the random seed (e.g., using a SHA-256 hashing algorithm) N times, where N is based on the difference between the minimum or maximum in the range and the actual value in the user data. For example, if the financial institution server 110 is proving that the distributions from the retirement account are at least 100% of the RMD, and the actual distributions are 106% of the RMD, the financial institution server 110 may hash the random seed six times to generate the proof and sign the proof with a cryptographic private key. The financial institution server 110 may also hash the random seed M times to generate encrypted user data, where M is based on the actual value in the user data. For example, the financial institution server 110 may hash the random seed 106 times. Then the financial institution server 110 sends the proof statement and the encrypted user data to the regulatory organization 140. The regulatory organization 140 verifies the cryptographic signature included in the proof statement. The regulatory organization 140 also hashes the proof Z times, where Z is the minimum or maximum in the range. For example, the regulatory organization 140 may hash the proof 100 times to generate a verification. Then the regulatory organization 140 compares the verification to the encrypted user data. Because the account's actual distribution, M is Z+N, the encrypted user data generated by hashing the random seed M times should equal the verification generated by first hashing the random seed N times to generate the proof and then hashing the random seed Z times. Also, because a hash function is a one-way function, it cannot be undone to uncover the original seed and/or the actual distribution. If the verification and the encrypted user data are the same, the regulatory organization 140 determines that the financial institution server 110 has proved that the account data is within the particular range.

This is one example of a ZKP for ease of illustration only. ZKPs may be generated in any suitable manner to cryptographically prove that the account and/or transaction has a particular attribute or satisfies a condition without revealing the account and/or transaction data.

In one aspect, the smart contract manager module 440 generates smart contracts for inclusion in the distributed ledger 122. The smart contract manager module 440 may compile programming code, such as Solidity or Vyper, into bytecode to be included in the distributed ledger 122. The smart contract manager module 440 may receive manually generated programming code and/or code that has been generated by regulatory monitoring module 118, such as regulatory compliance code 340.

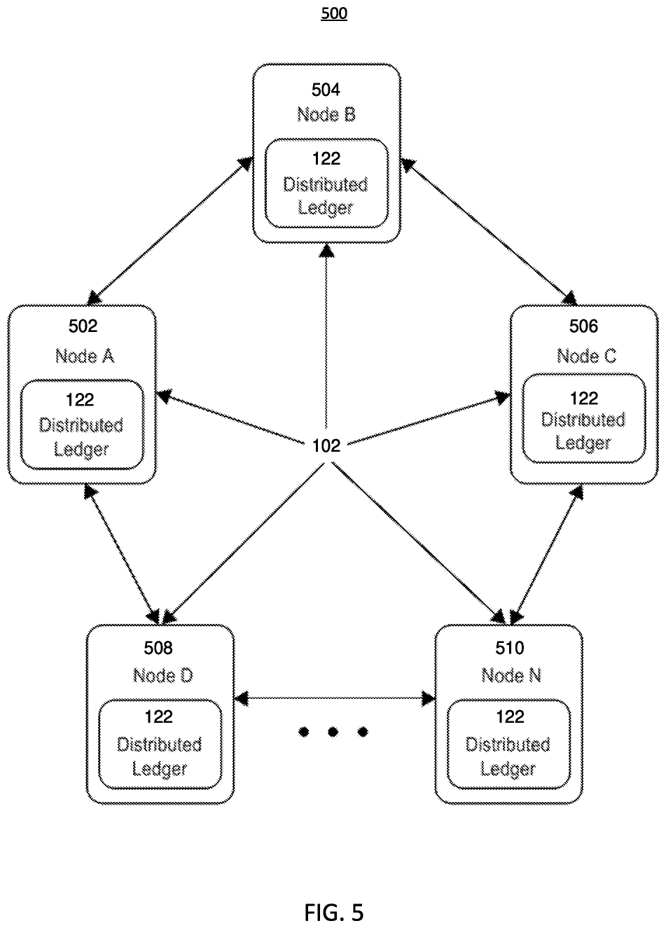

FIG. 5 depicts an exemplary distributed ledger system 500 for receiving and responding to requests to store user data. The system 500 includes the distributed ledger 122 and a plurality of nodes 502, 504, 506, 508, and 510, which may be storage centers, or may be any suitable computing devices, such as the financial institution server 110, third-party financial institutions 130, regulatory organizations 140, and/or validator nodes 150. Each node maintains a copy of the distributed ledger 122. As changes are made to the distributed ledger 122, each node receives the change via the network 102 and updates its respective copy of the distributed ledger 122. A consensus mechanism may be used by the nodes 502-510 in the distributed ledger system 500 to decide whether it is appropriate to make received changes to the distributed ledger 122.

Each node in the system therefore has its own copy of the distributed ledger 122, which is identical to every other copy of the distributed ledger 122 stored by the other nodes. The distributed ledger system 500 may be more robust than a central authority database system because of the distributed ledger's decentralized nature. As such, there is no single point of failure on the distributed ledger system 500 as there would be in a centralized system.

In one aspect, the distributed ledger system 500 is a private, permissioned system. Each of the nodes 502-510 may be operated by the financial institution or by a regulatory organization. In one aspect, the distributed ledger system 500 is a public system or a system operated by an industry consortium. One or more nodes 502-510 may be operated by a third-party financial institution or an anonymous member of the public.

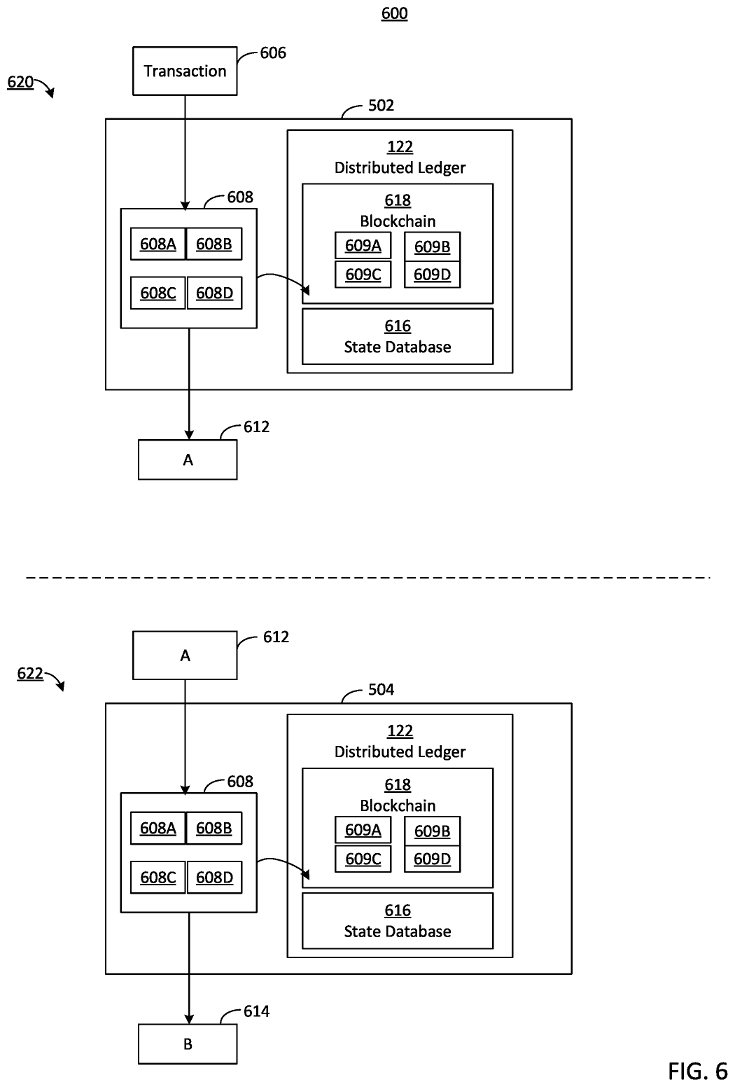

FIG. 6 depicts exemplary validating network nodes and an exemplary transaction flow 600 on a distributed ledger network for resolving transactions. FIG. 6 includes two time frames 620 and 622 represented by the top and bottom sides of the dotted line, respectively, Node A 502 and Node B 504 (which may be two storage centers), a set of transactions 608A-608D, a set of blocks of transactions 609A-609D, the distributed ledger 122, and a blockchain 618.

The block propagation flow 600 may begin with Node A 502 receiving transaction 606 at time 620. When Node A 502 confirms that transaction 606 is valid, Node A 502 may add the transaction to a newly generated block 608. As part of adding the transaction 606 to block 608, Node A 502 may provide proof of replication and/or proof of spacetime as proof that Node A 502 is storing a physically unique copy of original data and that the data is being stored continuously over time to generate the block 608. In other implementations, Node A 502 may solve a cryptographic puzzle and include the solution in the newly generated block 608 as proof of the work done to generate the block 608. Alternatively, a proof of stake algorithm may be used to generate the block 608, whereby Node A 502 “stakes” an amount of a digital token used on the network, however, the network itself determines the node that will mint the new block. In other embodiments, the transaction 606 may be added to a pool of transactions until a sufficient number of transactions in the pool exist to form a block. Node A 502 may transmit the newly created block 608 to the network at time 612. Before or after propagating the block 608, Node A 502 may add the block 608 to its copy of the blockchain 618.

While proof of replication, proof of spacetime, proof of work, and proof of stake are described herein as consensus algorithms for selecting a node to mint a new block; these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of authority, proof of weight, Byzantine fault tolerance, tangle consensus algorithms, block lattice consensus algorithms, etc.

In any event, the transactions 609A-609D may include updates to a state database 616. The state database 616 may contain current values of variables created by smart contracts deployed on the blockchain 618. Validated blocks, such as block 608, may include transactions effecting state variables in state database 616. At time 622, Node B 504 may receive the newly created block 608 via the network at 612. Node B 504 may verify that the block of transactions 608 is valid by checking the proof of replication and/or proof of spacetime, or checking the solution to the cryptographic puzzle provided in the block 608. If the solution is accurate, then Node B 504 may add the block 608 to its blockchain 618 and make any updates to the state database 616 as rejected by the transactions in block 608. Node B 504 may then transmit the block 608 to the rest of the network at time 614.

In some embodiments, the blockchain includes several blocks connected together to form a chain of blocks of transactions. To cryptographically link blocks and transactions together, each block in the blockchain organizes its transactions into a Merkle Tree. In a Merkle Tree each transaction is hashed according to a cryptographic hashing algorithm (e.g., SHA-256), and the resulting output hash is then combined with the hash of another transaction. Then the combined result is also hashed according to the cryptographic hashing algorithm. This output is then combined with the hash of two other transactions, and this process is repeated until all of the transactions in the block are combined and hashed to generate a Merkle root that is used in the header for a block. If any single transaction in the block is tampered with, a different Merkle root would be generated since the Merkle root is a combination of the hashes of all the transactions in the block.

In other words, the transactions may be hashed using a cryptographic hash algorithm, such as the algorithms discussed above, and the hash of each transaction may be stored in the tree. As the tree is constructed, the hash of each adjacent node at the same level may be hashed together to create a new node that exists at a higher level in the tree. Therefore, the node at the top of the tree or Merkle root is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

To verify that a block is valid, a node may compare the Merkle root of the block to the Merkle root for the same block included in other nodes' copies of the blockchain. Thus, the Merkle root can be used as proof of the transactions included in the block and as proof that the contents of the block have not been tampered with if the Merkle root is the same in each node's copy of the block.

In one implementation, documents stored “on” a blockchain are documents that have been hashed according to a cryptographic hashing algorithm (e.g., SHA-256) and the resulting output hash has been included in a transaction in a block that has been accepted by the network nodes as satisfying the consensus rules of the blockchain. As such, the documents may be later verified or validated by comparing the hash of the documents to the hash stored on the blockchain. For example, if a set of documents results in a SHA-256 hash that was recorded on a blockchain on a certain date, then the blockchain provides cryptographic proof that the documents existed as of that date.

One way of storing a document on a blockchain is to broadcast a transaction including a hash of the document to the network, which will be included in a block if the transaction satisfies all of the consensus rules of the network. In some implementations, the blockchain is a permissioned ledger, meaning only authorized network participants may broadcast transactions. In other implementations, only some authorized network participants may make certain transactions. For example, user data may be uploaded to the blockchain as the encrypted user data is stored at a storage center. Only a cryptographic hash of the encrypted user data may be included in the blockchain, such that the encrypted user data may be verified using the blockchain even if it is obtained by a party off-chain.

Validating network nodes may verify that a signed transaction or signed message was signed by the private cryptographic key corresponding to the published public cryptographic key owned by the storage center storing the encrypted user data. In at least one implementation, a valid proof-of-identity may be applied as a consensus rule by the blockchain network. As such, any transaction attempting to store data without a cryptographic proof-of-identity matching an identity authorized to store data is rejected by the network as non-compliant with the consensus rule. Each storage center may be assigned a public key/private key pair which is identified in the blockchain network as corresponding to the storage center. If the validating network nodes receive a transaction including data storage information that is not from an authorized storage center, the validating network nodes reject the transaction.

In one aspect, the distributed ledger 122 may implement a privacy-enhanced protocol, e.g., MimbleWimble, that enables confidential transactions (CTs). CTs do not reveal the addresses of the sender or receiver or the number of tokens sent in the distributed ledger. CTs use the Pedersen Commitment scheme, in which the parties to a transaction share a “blinding key.” The blinding key replaces the parties' addresses in the distributed ledger and encrypts the inputs and outputs of the transaction, thus enhancing privacy.

For example, Susan's digital wallet contains five tokens, and she wants to send two tokens to John. Susan generates a blinding key and combines it with a single hash after receiving John's address to create a confidential address. Although it is recorded in the distributed ledger, no one except Susan and John knows that the confidential address is associated with John's address. Then Susan creates a CT by generating a Pedersen Commitment with the blinding key and the output of two tokens. Thus, the amount that Susan sends John is hidden to other participants, but Susan and John can see the amount because they both have a public blinding key.

Pedersen Commitments solve the problem of validating whether the sum of encrypted transaction inputs is equal to the sum of the encrypted transaction outputs to ensure that no tokens were created or destroyed. Pedersen Commitments hash data and verify the data behind the hash using basic algebraic operations. For Susan's confidential transaction, Alice has the Pedersen Commitment of five tokens. When Susan sends John two tokens, Susan creates a hash using a mathematical formula. The same mathematical formula is then used to send two tokens to the exchange address. The two hashes are multiplied and compared to the Pedersen's Commitment of Susan's address; if the result is the same, the transaction is valid. To enable auditing, Susan or John can transfer the blinding key to a third party, such as the regulatory organization 140, to reveal the transaction inputs and outputs.

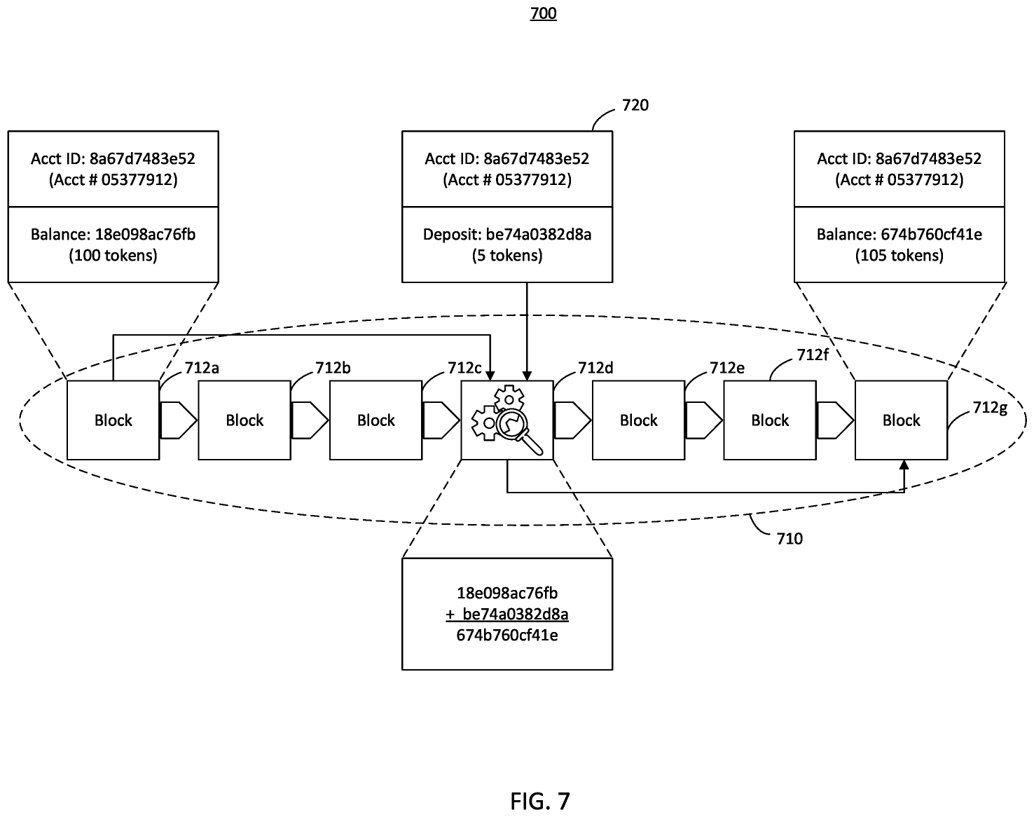

FIG. 7 depicts an exemplary environment 700 for implementing a fully homomorphic encryption (FHE) scheme, such as BGV, CKKS, BFV, FHEW, and TFHE, to enable privacy for blockchain transactions. FHE enables encrypted data processing such that smart contracts may perform computations on encrypted data input(s) to produce encrypted data output(s) without the need for decryption at any stage, thus ensuring data privacy during computation. FHE provides additive homomorphism, Enc(m₁)+Enc(m₂)=Enc(m₁+m₂), and multiplicative homomorphism, Enc(m₁)*Enc(m₂)=Enc(m₁*m₂).

In one aspect, the environment 700 includes a blockchain 710 comprising a plurality of blocks 712a-712g. Each block may be linked to the previous block by including a hash of the previous block.

In one aspect, block 712a includes financial account information, including the account ID and account balance. The account ID may be a hash of an account number at a financial institution. The account balance may be FHE encrypted using a shared secret key or an account holder public key to prevent other participants in the blockchain from viewing the plaintext balance.

In one aspect, some portion of the financial account information may be stored in a decentralized file storage system. The financial institution server 110 may store an encrypted version of the financial account information at an address derived from a content identifier (CID) in the decentralized file storage system. The CID may be the output of the financial account information being hashed according to a cryptographic hashing algorithm (e.g., SHA-256). In this manner, the CID uniquely corresponds to the financial account information, and if the financial account information is altered in any way the resulting hash will be different from the CID. The decentralized file storage system may include storage centers acting as nodes in a distributed ledger network.

In one aspect, the blockchain 710 includes a transaction smart contract 712d. The transaction smart contract 712d may include instructions for receiving one or more transaction inputs in plaintext and/or ciphertext, performing one or more financial transactions, and generating one or more transaction outputs in plaintext and/or ciphertext.

For example, an account holder may want to deposit five tokens into his or her account. After the financial institution receives the deposit request identifying the account number and deposit amount, the financial institution server 110 may generate a deposit transaction 720. The deposit transaction 720 may include the hashed account number that will receive the deposit and a deposit amount FHE encrypted by a shared secret key or an account holder public key. In one aspect, the financial institution server 110 transmits the deposit transaction 720 to the blockchain network and transmits the resulting block address and the address of block 712a to the transaction smart contract 712d. The transaction smart contract 712d may add the ciphertext account balance from block 712a to the ciphertext deposit amount from deposit transaction 720 to generate a ciphertext updated account balance. The transaction smart contract 712d may transmit the hashed account number and the ciphertext updated account balance to the blockchain network to cause the network to generate new block 712g including the hashed account number and the ciphertext updated account balance.

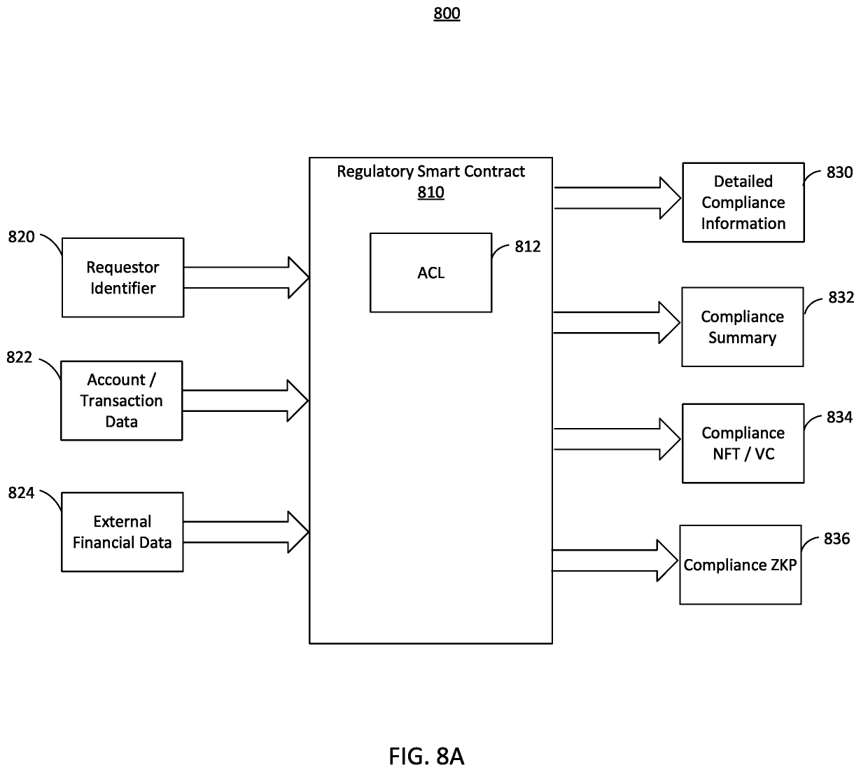

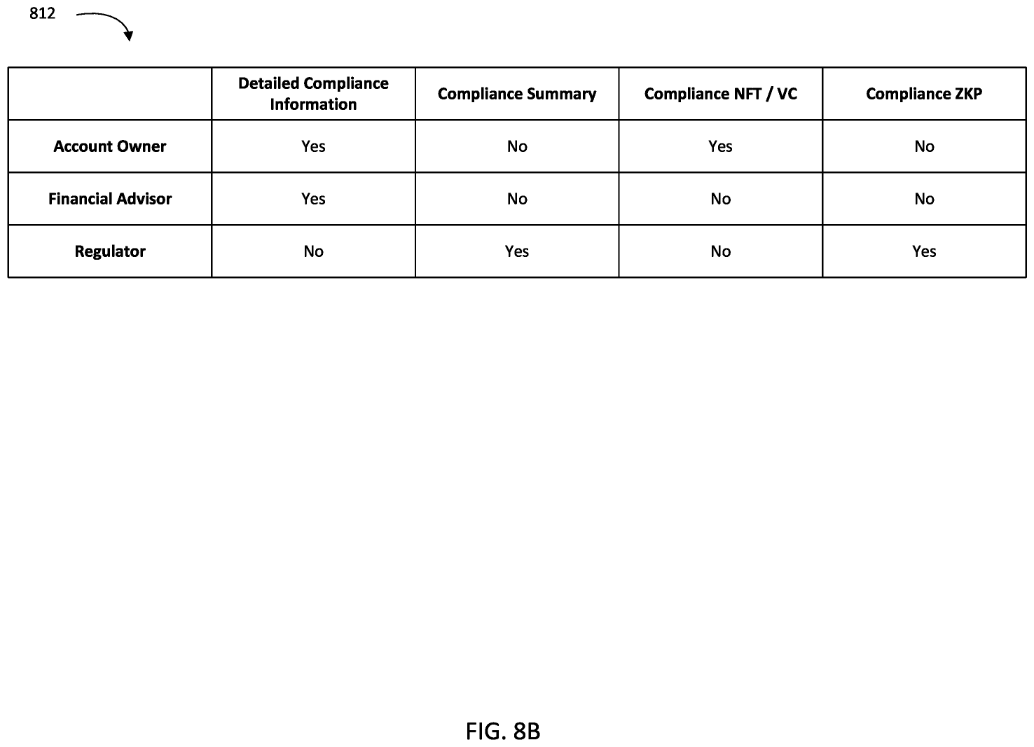

FIG. 8A depicts an exemplary environment 800 for determining regulatory compliance of a financial account and/or financial transaction. The environment 800 includes one or more regulatory smart contracts 810 in the distributed ledger. The regulatory smart contract 810 receives one or more inputs 820-824, performs calculations on the inputs 820-824 to determine regulatory compliance, and generates one or more outputs 830-836. The regulatory smart contract 810 may include an access control list (ACL) 812 that specifies what functions and/or outputs are allowed for different requestors.

In one aspect, a requestor may transmit a requestor identifier 820 to the regulatory smart contract 810. The requestor identifier 820 may provide the identity of the individual or organization, e.g., account holder, transaction participant, financial advisor, or regulatory organization, that submitted the request to the regulatory smart contract 810. The requestor identifier 820 may include a DID or proof of identity from a central authority. The requestor identifier 820 may be signed by a private key associated with the requestor.

In one aspect, a requestor may transmit account/transaction data 822 to the regulatory smart contract 810. The account/transaction data 822 may include information associated with one or more accounts and/or transactions. For example, an RMD calculation for a retiree may require information about all of the retiree's retirement accounts held at one or more financial institutions. The account/transaction data 822 may include demographics, e.g., age, salary, etc., of the individual account holder. The account/transaction data 822 may be in plaintext or encrypted. The account/transaction data 822 may include information located in a block on the distributed ledger, information provided by an oracle, or a CID pointing to one or more documents in a distributed storage system.

In one aspect, a requestor may transmit external financial data 824 to the regulatory smart contract 810. The external financial data 824 may be transmitted via an oracle. The external financial data may include public information, such as financial market data, that is not stored in the distributed ledger or distributed storage.

In one aspect, the regulatory smart contract 810 may output detailed compliance information 830. The detailed compliance information 830 may include a copy of the account/transaction data 822 and a detailed explanation of why the account or transaction is or is not compliant. For example, the detailed compliance information 830 may include private information such as the balance of each retirement account, the amount(s) withdrawn from each retirement account during the present tax year, the account holder's RMD, and any additional amount required to be withdrawn to be compliant. The detailed compliance information 830 may be encrypted with the public key of the requestor and stored in the distributed ledger or distributed storage.

In one aspect, the regulatory smart contract 810 may output a compliance summary 832. The compliance summary 832 may include a less private summary of why the account or transaction is or is not compliant. For example, the compliance summary 832 may include an RMD compliance/non-compliance certificate and/or a percentage of withdrawals made during the present tax year compared to the RMD. The compliance summary 832 may be encrypted with the public key of the regulatory organization and stored in the distributed ledger or distributed storage.

In one aspect, the regulatory smart contract 810 may output a compliance NFT/VC 834. The compliance NFT/VC 834 may comprise a non-fungible token or a verifiable credential. The compliance NFT/VC 834 may include a less private summary, such as the information included in the compliance summary 832. The compliance NFT/VC 834 may be signed with a private key or digital certificate associated with the regulatory smart contract 810, stored in the distributed ledger, and subsequently transferred to a digital wallet.

In one aspect, the regulatory smart contract 810 may output a compliance ZKP 836. The compliance ZKP 836 may provide a proof that the data included in the detailed compliance information 830 falls within a certain range without revealing the included data. For example, the compliance ZKP 836 may provide proof that an individual's total retirement account distributions are 105% to 110% of the RMD.

The regulatory smart contract 810 may comprise a block of unencrypted bytecode in the distributed ledger. To enable a regulatory organization to audit the regulatory smart contract, regulatory compliance code may be provided to the regulatory organization. The regulatory organization may review the regulatory compliance code to verify that the code accurately determines compliance with one or more regulations. The regulatory organization can compile the regulatory compliance code and verify that the compiled bytecode matches the bytecode of the regulatory smart contract 810.

FIG. 8B depicts an exemplary ACL 812 that controls requestors' access to the regulatory smart contract's 810 functions and/or outputs. The ACL 812 may provide different permissions to individual requestors or classes of requestors, such as account owners, financial advisors, regulatory organizations, etc. The permissions may include grant/deny, modify/read, or any other suitable permissions.

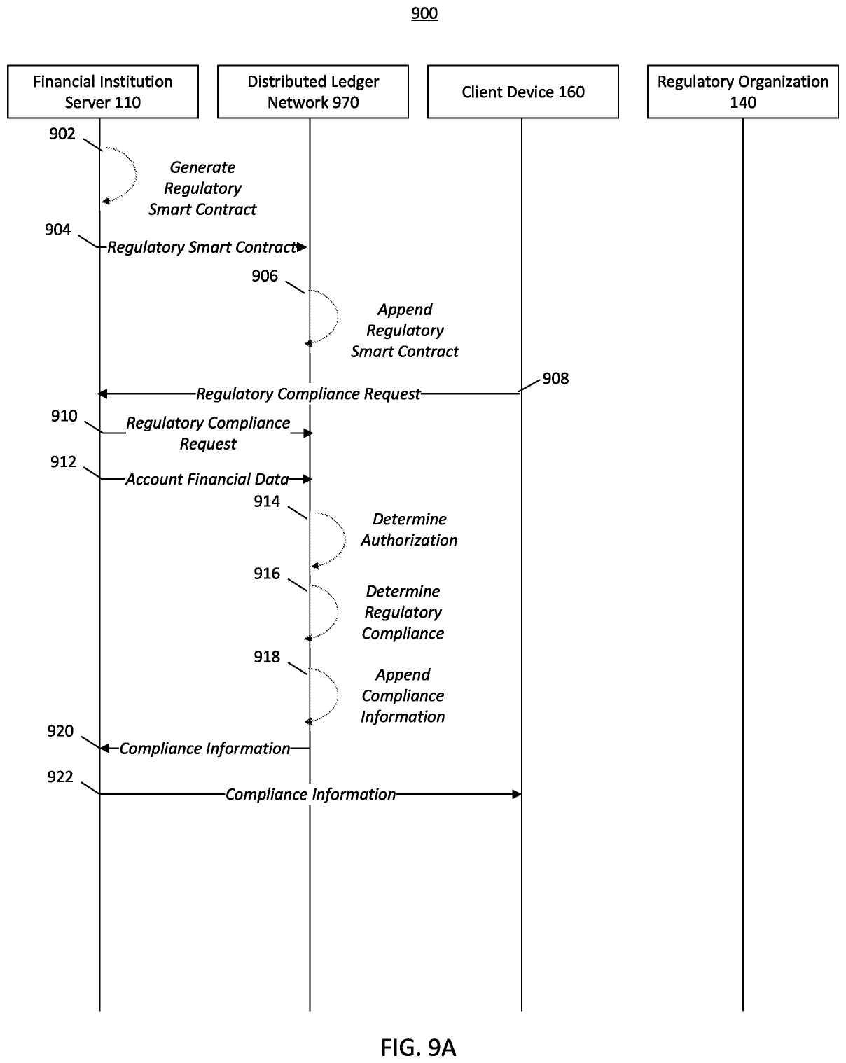

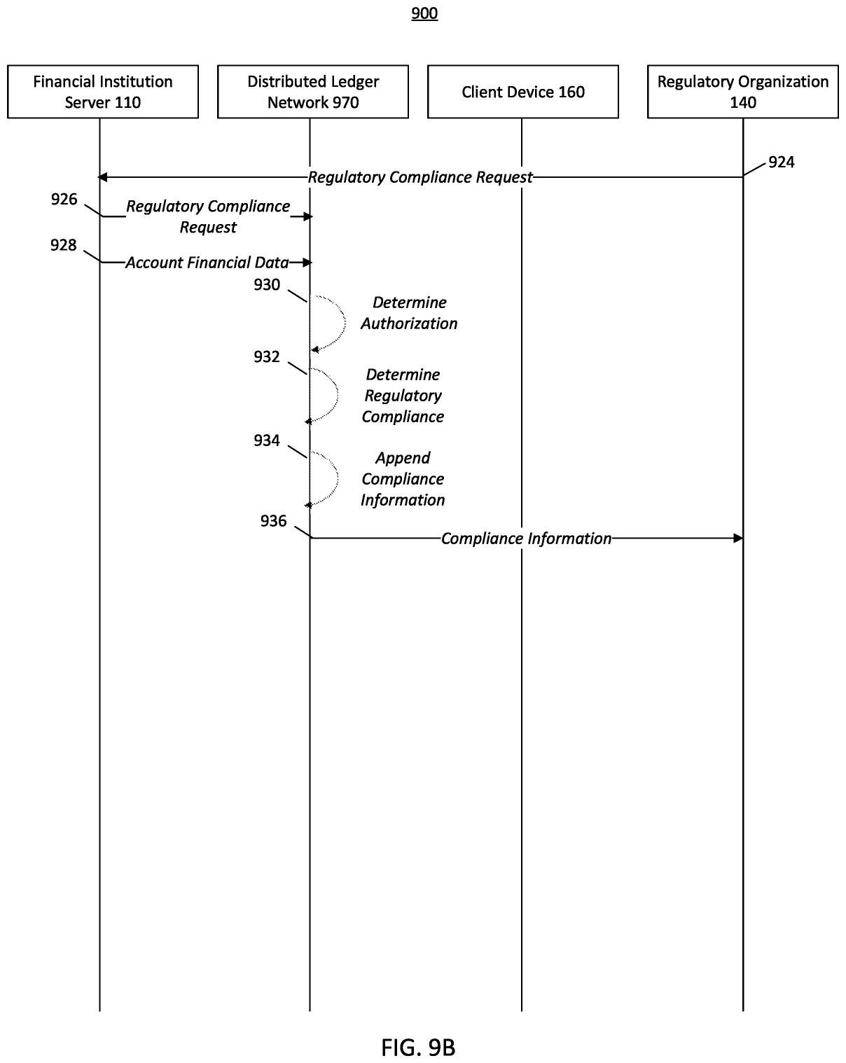

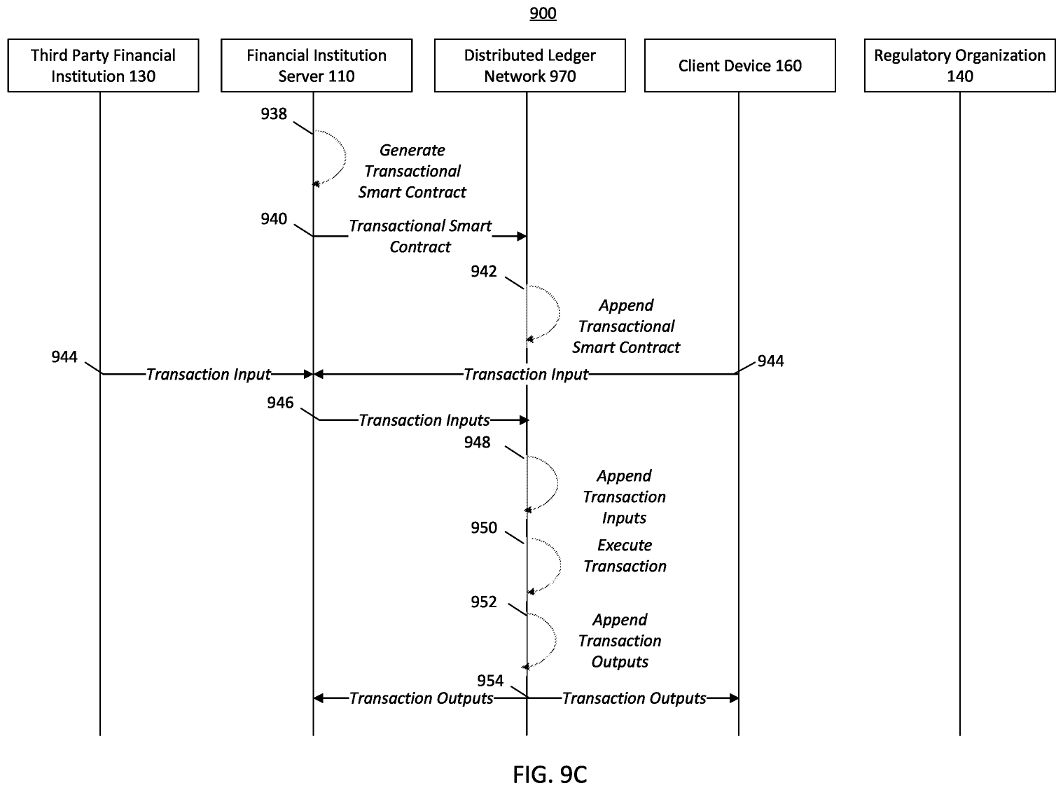

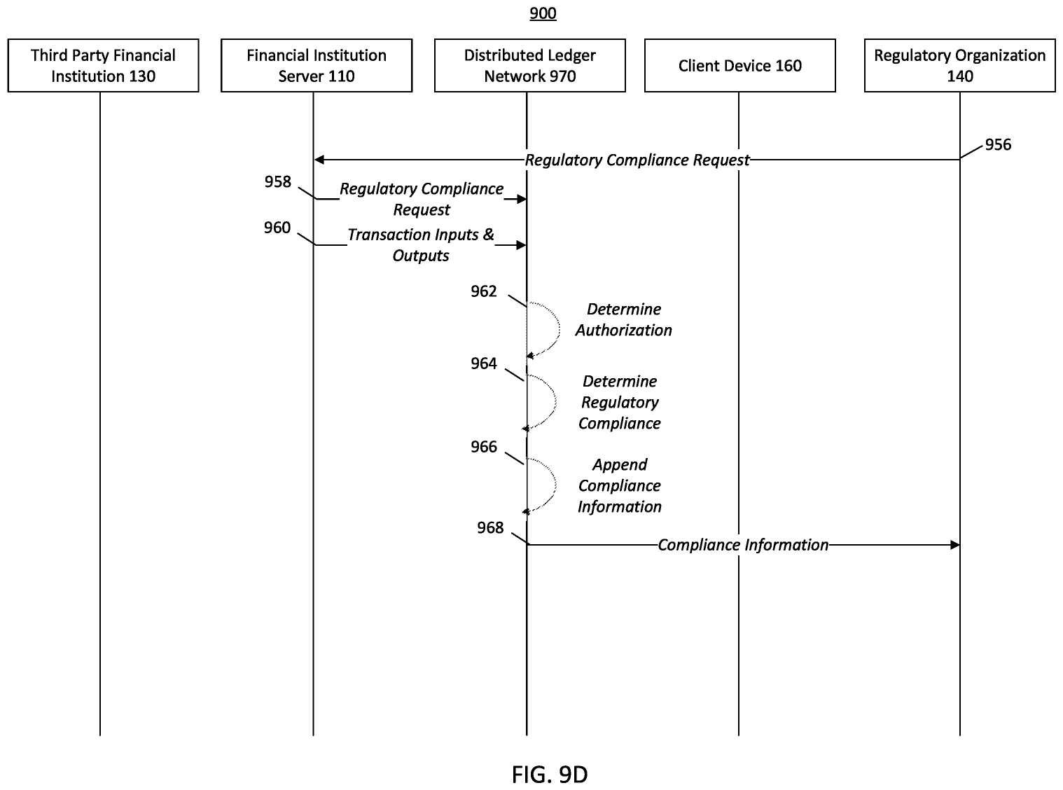

FIGS. 9A-9D depict an exemplary sequence diagram 900 for requesting, determining, and providing proof of regulatory compliance for a financial account and/or financial transaction. The sequence diagram 900 includes a timeline of events affecting the financial institution server 110, distributed ledger network 970, third-party financial institution 130, client device 160, and regulatory organization 140. The distributed ledger network 970 may include the nodes of the distributed ledger network, including validator nodes 150. Not all steps illustrated in the sequence diagram 900 are mandatory, and the steps may be performed in an order different from what is depicted.

FIG. 9A illustrates a sequence of generating a regulatory smart contract, appending the regulatory smart contract to the distributed ledger, and receiving and responding to a regulatory compliance request from a client device 160. At step 902, the financial institution server 110 generates the regulatory smart contract. The regulatory smart contract may be manually programmed or computer-generated, e.g., by the MLOM 224. The regulatory smart contract may include bytecode instructions for determining whether a financial account or a financial transaction is compliant with one or more financial regulations.

At step 904, the financial server 110 broadcasts the regulatory smart contract to the distributed ledger network 970. At step 906, the distributed ledger network 970 validates the regulatory smart contract using a consensus algorithm and, if valid, appends the regulatory smart contract to the distributed ledger.

At step 908, the client device 160 transmits a regulatory compliance request to the financial institution server 110. The request may be transmitted via a mobile application, web page, e-mail, or any other suitable communication mechanism. The request may specify which account(s) and which regulation(s) the requestor wishes to verify. The request may include a verification of the requestor's identity, such as a username and password or the requestor's DID.

The financial institution server 110 then transmits the regulatory compliance request to the regulatory smart contract on the distributed ledger network 970 at step 910. The request at step 910 may be reformatted to satisfy any input format requirements of the regulatory smart contract. The request may include the requestor's DID, the DID of the financial institution server 110, or any other suitable identifier.

At step 912, the financial institution server 110 transmits account financial data to the regulatory smart contract on the distributed ledger network 970. The account financial data may include balances, holdings, transaction activity, etc. The account financial data may be transmitted in plaintext or ciphertext. The financial institution server 110 may transmit an address of a block on the distributed ledger containing the account financial data.

The regulatory smart contract running on the distributed ledger network 970 may determine whether the requestor is authorized to request regulatory compliance at step 914. The regulatory smart contract may determine what functions and outputs are authorized for the requestor. The regulatory smart contract may use an ACL, such as ACL 812, to determine authorization.

At step 916, the regulatory smart contract may determine regulatory compliance of the financial account. The regulatory smart contract may determine regulatory compliance by inputting the account financial data to compliance tests within the smart contract.

At step 918, the regulatory smart contract may append compliance information to a block in the distributed ledger. The compliance information may include detailed compliance information 830 and/or a compliance NFT and/or VC 834. The compliance information may be encrypted with a private key associated with the regulatory smart contract or digitally signed by the regulatory smart contract.

The financial institution server 110 may retrieve the compliance information from the regulatory smart contract at step 920. The financial institution server 110 may receive an address of a block including the compliance information or may receive the compliance information itself.

At step 922, the financial institution server 110 may transmit the compliance information to the client device 160. The compliance information may be formatted into a presentation, spreadsheet, text summary, or any other suitable format.

FIG. 9B illustrates a regulatory compliance request and response initiated by a regulatory organization 140. At step 924, the regulatory organization 140 transmits a regulatory compliance request to the financial institution server 110. The regulatory compliance request may specify one or more financial accounts and include the DID or other credentials of the regulatory organization 140.

At step 926, the financial institution server 110 transmits the regulatory compliance request to the regulatory smart contract on the distributed ledger network 970. The financial institution server 110 transmits the account financial data to the regulatory smart contract at step 928. At step 930, the regulatory smart contract determines the authorization of the regulatory organization 140. At step 932, the regulatory smart contract determines the regulatory compliance of the one or more financial accounts. The regulatory smart contract then appends the compliance information to the distributed ledger at step 934. The compliance information may include a compliance summary 832 or a compliance ZKP 836. At step 936, the regulatory smart contract transmits the compliance information to the regulatory organization. The regulatory smart contract may transmit an address of the block containing the compliance information or may transmit the compliance information itself.

FIGS. 9C-9D illustrate generation of a transactional smart contract, executing a transaction, and determining regulatory compliance of the transaction. At step 938, the financial institution server 110 generates a transactional smart contract. The transactional smart contract may include bytecode instructions for performing one or more financial transactions. At step 940, the financial institution server 110 may broadcast the transactional smart contract to the distributed ledger network 970. The distributed ledger network 970 may validate the transactional smart contract and append the transactional smart contract to the distributed ledger.

At step 944, the client device 160 and/or the third party financial institution provide transaction inputs to the financial institution server 110. The transaction inputs may include source and destination accounts, transaction amounts, transaction type, and any other suitable information. The financial institution server 110 may include its own information to the received transaction inputs and transmit the transaction inputs to the transactional smart contract on the distributed ledger network at step 946. The transaction inputs may be plaintext, ciphertext, or the address(es) of block(s) on the distributed ledger comprising the transaction input data.

At step 948, the transactional smart contract may append the transaction inputs to the distributed ledger. The transactional smart contract may, using the transaction inputs, execute the requested transaction at step 950. At step 950, the transactional smart contract may generate transaction outputs, such as transaction confirmations and updated account balances, and append the transaction outputs to the distributed ledger network at step 952. The transactional smart contract may transmit the transaction outputs to the financial institution server 110 and/or client device at step 954. The transaction outputs may be plaintext, ciphertext, or the address(es) of block(s) on the distributed ledger comprising the transaction output data.

At step 956, the regulatory organization 140 transmits a regulatory compliance request to the financial institution server 110. The regulatory compliance request may specify one or more financial transactions and include the DID or other credentials of the regulatory organization 140. At step 958, the financial institution server 110 transmits the regulatory compliance request to the regulatory smart contract on the distributed ledger network 970. The financial institution server 110 transmits the transaction inputs and transaction outputs to the regulatory smart contract at step 960. At step 962, the regulatory smart contract determines the authorization of the regulatory organization 140. At step 964, the regulatory smart contract determines the regulatory compliance of the one or more financial transaction. The regulatory smart contract then appends the compliance information to the distributed ledger at step 966. The compliance information may include a compliance summary 832 or a compliance ZKP 836. At step 968, the regulatory smart contract transmits the compliance information to the regulatory organization. The regulatory smart contract may transmit an address of the block containing the compliance information or may transmit the compliance information itself.

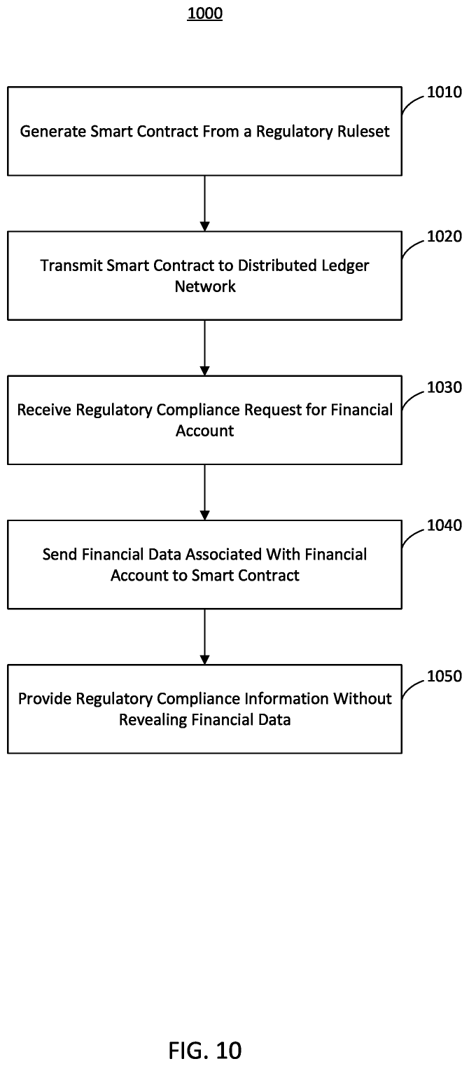

FIG. 10 depicts a flow diagram of an example computer-implemented method 1000 for determining regulatory compliance of a financial account. The method 1000 may operate as a stand-alone method, and/or may operate in conjunction with embodiments of at least a portion of the system 100 and of any one or more components and/or devices related thereto, and/or with other systems, processors, databases and/or devices. For example, the financial institution server 110 may execute at least a portion of the method 1000. In some embodiments, the financial institution server 110 may execute at least a portion of the method 1000 in conjunction with one or more other components of the system 100, such as the third-party financial institutions 130, regulatory organizations 140, validator nodes 150, and/or client device 160. Further, the method 1000 may include additional or alternate steps other than those described with respect to FIG. 10 in embodiments.

In one embodiment, the method 1000 may include retrieving from an authoritative source one or more regulations. The regulations may comprise unstructured financial rule text. The regulations may be promulgated by a regulatory authority. In one embodiment, the method 1000 may include generating by an NLP service a regulatory ruleset from the one or more regulations.

In one embodiment, the method 1000 may include at block 1010 generating a smart contract from the regulatory ruleset. The regulatory ruleset may include programmatic logic for determining regulatory compliance. The smart contract may include executable bytecode. The smart contract may configured to receive financial data associated with a financial account, determine from the financial data whether the financial account is compliant, and/or responsive to determining that the financial account is compliant, generating regulatory compliance information. The regulatory compliance information may include cryptographic proof of regulatory compliance, such as an encrypted compliance summary, compliance NFT, compliance VC, or compliance ZKP. The encrypted compliance summary may be encrypted with a private key associated with the smart contract or financial account.

In one embodiment, the method 1000 may include at block 1020 transmitting the smart contract to at least one other participant in a distributed ledger network to deploy the smart contract. The smart contract may be stored in a distributed ledger maintained by participants in the distributed ledger network.

In one embodiment, the method 1000 may include at block 1030 receiving a request from an organization regarding regulatory compliance of the financial account. The organization may be a government agency, industry association, or other suitable organization.

In one embodiment, the method 1000 may include retrieving external financial data, such as market data. The external financial data may be retrieved from one or more external data sources.

In one embodiment, the method 1000 may include at block 1040 sending financial data associated with the financial account to the smart contract. The financial data may include account holder information, account number, balances, transactions, and/or any other suitable data. The financial data may be encrypted, such as FHE encrypted. The method 1000 may include sending external financial data to the smart contract.

In one embodiment, the method 1000 may include at block 1050 providing the regulatory compliance information to the organization without revealing the financial data. A public cryptographic key associated with the smart contract or financial account may be provided.

In one embodiment, the method 1000 may include storing the regulatory compliance information in a digital wallet associated with the financial account. The method 1000 may include storing the regulatory compliance information in the distributed ledger. The method 1000 may include transmitting the regulatory compliance information to at least one other participant in the distributed ledger network.

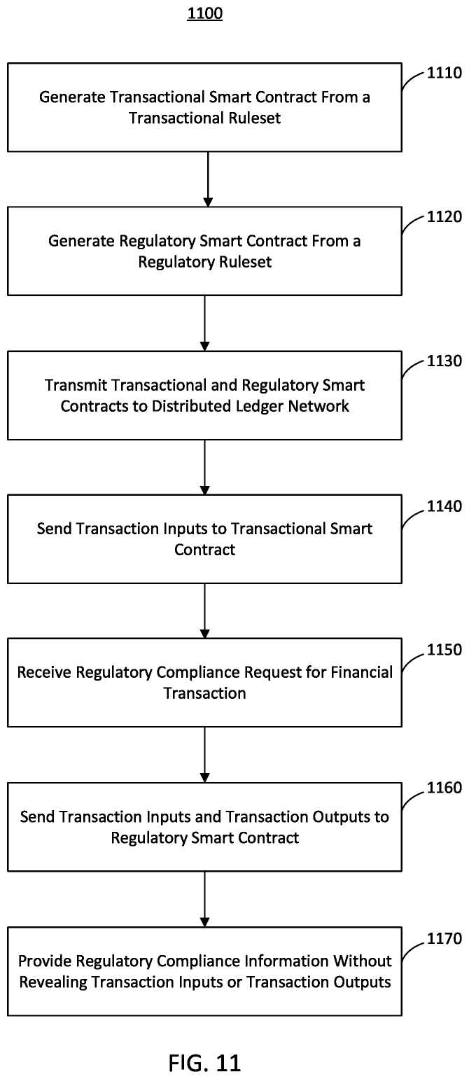

FIG. 11 depicts a flow diagram of an example computer-implemented method 1100 for determining regulatory compliance of a financial transaction. The method 1100 may operate as a stand-alone method, and/or may operate in conjunction with embodiments of at least a portion of the system 100 and of any one or more components and/or devices related thereto, and/or with other systems, processors, databases and/or devices. For example, the financial institution server 110 may execute at least a portion of the method 1100. In some embodiments, the financial institution server 110 may execute at least a portion of the method 1100 in conjunction with one or more other components of the system 100, such as the third-party financial institutions 130, regulatory organizations 140, validator nodes 150, and/or client device 160. Further, the method 1100 may include additional or alternate steps other than those described with respect to FIG. 11 in embodiments.

In one embodiment, the method 1100 may include retrieving from an authoritative source one or more regulations. The regulations may comprise unstructured financial rule text. The regulations may be promulgated by a regulatory authority. In one embodiment, the method 1100 may include generating by an NLP service a regulatory ruleset from the one or more regulations.

In one embodiment, the method 1100 may include at block 1110 generating a transactional smart contract from a transactional ruleset. The transactional ruleset may include programmatic logic for executing one or more financial transactions. The transactional smart contract may include executable bytecode. The transactional smart contract may configured to receive one or more transaction inputs associated with a financial traction, execute the financial transaction using the one or more transaction inputs, and/or generate one or more transaction outputs.

In one embodiment, the method 1100 may include at block 1120 generating a smart contract from the regulatory ruleset. The regulatory ruleset may include programmatic logic for determining regulatory compliance. The smart contract may include executable bytecode. The smart contract may configured to receive the one or more transaction inputs and the one or more transaction outputs, determine from the transaction inputs and the transaction outputs whether the financial transaction is compliant, and/or responsive to determining that the financial transaction is compliant, generating regulatory compliance information. The regulatory compliance information may include cryptographic proof of regulatory compliance, such as an encrypted compliance summary, compliance NFT, compliance VC, or compliance ZKP. The encrypted compliance summary may be encrypted with a private key associated with the smart contract or a financial account.

In one embodiment, the method 1100 may include at block 1130 transmitting the transactional smart contract and the regulatory smart contract to at least one other participant in a distributed ledger network to deploy the transactional smart contract and the regulatory smart contract. The transactional smart contract and the regulatory smart contract may be stored in a distributed ledger maintained by participants in the distributed ledger network.

In one embodiment, the method 1100 may include at block 1140 sending transaction inputs to the transactional smart contract.

In one embodiment, the method 1100 may include at block 1150 receiving a request from an organization regarding regulatory compliance of the financial transaction. The organization may be a government agency, industry association, or other suitable organization.

In one embodiment, the method 1000 may include retrieving external financial data, such as market data. The external financial data may be retrieved from one or more external data sources.

In one embodiment, the method 1100 may include at block 1160 sending the transaction inputs and the transaction outputs to the regulatory smart contract. The transaction inputs and the transaction outputs may include account holder information, account numbers, balances, amounts transferred, and/or any other suitable data. The transaction inputs and transaction outputs may be encrypted, such as FHE encrypted. The method 1100 may include sending external financial data to the regulatory smart contract.

In one embodiment, the method 1100 may include at block 1170 providing the regulatory compliance information to the organization without revealing the transaction inputs or transaction outputs. A public cryptographic key associated with the regulatory smart contract or a financial account may be provided.

In one embodiment, the method 1100 may include storing the regulatory compliance information in a digital wallet associated with a financial account. The method 1100 may include storing the regulatory compliance information in the distributed ledger. The method 1100 may include transmitting the regulatory compliance information to at least one other participant in the distributed ledger network.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A computer-implemented method for automating regulatory compliance of a financial account, the method comprising:
generating, by one or more processors, a smart contract from a regulatory ruleset, wherein the regulatory ruleset comprises programmatic logic for determining regulatory compliance, wherein the smart contract is configured to:
receive financial data associated with the financial account,
determine from the financial data whether the financial account is compliant, and
responsive to determining that the financial account is compliant, generate regulatory compliance information, wherein the regulatory compliance information comprises cryptographic proof of regulatory compliance;
transmitting, by the one or more processors, the smart contract to at least one other participant in a distributed ledger network to deploy the smart contract, wherein the smart contract is stored in a distributed ledger maintained by a network of participants;
receiving, by the one or more processors, a request from an organization regarding the regulatory compliance of the financial account;
sending, by the one or more processors, the financial data to the smart contract; and
providing, by the one or more processors to the organization, the regulatory compliance information without revealing the financial data.

2. The computer-implemented method of claim 1, wherein the regulatory compliance information comprises a non-fungible token (NFT).

3. The computer-implemented method of claim 1, wherein the regulatory compliance information comprises a summary of the financial data.

4. The computer-implemented method of claim 1, wherein the regulatory compliance information comprises information encrypted by a private cryptographic key associated with the financial account, and
wherein providing the regulatory compliance information further comprises providing, by the one or more processors to the organization, a public cryptographic key associated with the financial account.

5. The computer-implemented method of claim 1, further comprising:
storing, by the one or more processors, the regulatory compliance information in a digital wallet associated with the financial account.

6. The computer-implemented method of claim 1, wherein providing the regulatory compliance information comprises supplying, by the one or more processors to the organization, the regulatory compliance information via a zero-knowledge proof (ZKP).

7. The computer-implemented method of claim 1, wherein obtaining the regulatory ruleset comprises:
retrieving, by the one or more processors from an authoritative source, one or more regulations comprising unstructured financial rule text promulgated by a regulatory authority; and
generating, by a natural language processing (NLP) service running on the one or more processors, the regulatory ruleset from the one or more regulations.

8. The computer-implemented method of claim 1, further comprising:
retrieving, by the one or more processors, external financial data,
wherein sending the financial data to the smart contract further comprises sending, by the one or more processors, the external financial data to the smart contract.

9. The computer-implemented method of claim 1, further comprising:
storing, by the one or more processors, the regulatory compliance information in the distributed ledger; and
transmitting, by the one or more processors, the regulatory compliance information to at least one other participant in the distributed ledger network;

10. The computer-implemented method of claim 1, wherein the financial data is encrypted.

11. A computer-implemented method for automating regulatory compliance of a financial transaction, the method comprising:
generating, by one or more processors, a transactional smart contract from a transactional ruleset, wherein the transactional ruleset comprises programmatic logic for executing the financial transaction, wherein the transactional smart contract is configured to:
receive one or more transaction inputs associated with the financial transaction,
execute the financial transaction using the one or more transaction inputs, and
generate one or more transaction outputs;
generating, by one or more processors, a regulatory smart contract from a regulatory ruleset, wherein the regulatory ruleset comprises programmatic logic for determining regulatory compliance, wherein the regulatory smart contract is configured to:
receive the one or more transaction inputs and the one or more transaction outputs,
determine from the one or more transaction inputs and the one or more transaction outputs whether the financial transaction is compliant, and
responsive to determining that the financial transaction is compliant, generate regulatory compliance information, wherein the regulatory compliance information comprises cryptographic proof of regulatory compliance;
transmitting, by the one or more processors, the transactional smart contract and the regulatory smart contract to at least one other participant in a distributed ledger network to deploy the transactional smart contract and the regulatory smart contract, wherein the transactional smart contract and the regulatory smart contract are stored in a distributed ledger maintained by a network of participants;
sending, by the one or more processors, the one or more transaction inputs to the transactional smart contract;
receiving, by the one or more processors, a request from an organization regarding the regulatory compliance of the financial transaction;
sending, by the one or more processors, the one or more transaction inputs and the one or more transaction outputs to the regulatory smart contract; and
providing, by the one or more processors to the organization, the regulatory compliance information without revealing the one or more transaction inputs or the one or more transaction outputs.

12. The computer-implemented method of claim 11, wherein the regulatory compliance information comprises a non-fungible token (NFT).

13. The computer-implemented method of claim 11, wherein the regulatory compliance information comprises a summary of the one or more transaction inputs and the one or more transaction outputs.

14. The computer-implemented method of claim 11, wherein the regulatory compliance information comprises information encrypted by a private cryptographic key associated with a party associated with the financial transaction, and
wherein providing the regulatory compliance information further comprises providing, by the one or more processors to the organization, a public cryptographic key associated with the party.

15. The computer-implemented method of claim 11, further comprising:
storing, by the one or more processors, the regulatory compliance information in a digital wallet associated with a party associated with the financial transaction.

16. The computer-implemented method of claim 11, wherein providing the regulatory compliance information comprises supplying, by the one or more processors to the organization, the regulatory compliance information via a zero knowledge proof (ZKP).

17. The computer-implemented method of claim 11, wherein obtaining the regulatory ruleset comprises:
retrieving, by the one or more processors from an authoritative source, one or more regulations comprising unstructured financial rule text promulgated by a regulatory authority; and
generating, by a natural language processing (NLP) service running on the one or more processors, the regulatory ruleset from the one or more regulations.

18. The computer-implemented method of claim 11, further comprising:
retrieving, by the one or more processors, external financial data,
wherein sending the one or more transaction inputs and the one or more transaction outputs to the regulatory smart contract further comprises sending, by the one or more processors, the external financial data to the regulatory smart contract.

19. The computer-implemented method of claim 11, further comprising:
storing, by the one or more processors, the regulatory compliance information in the distributed ledger; and
transmitting, by the one or more processors, the regulatory compliance information to at least one other participant in the distributed ledger network.

20. The computer-implemented method of claim 11, wherein at least one of the one or more transaction inputs is encrypted, and at least one of the one or more transaction outputs is encrypted.
